(19) United States
(12) Patent Application Publication
(10) Pub. No.: US 2026/0248130 A1
(43) Pub. Date: Aug. 27, 2026

(54) ASCAROSIDES AND HERBICIDAL COMBINATIONS AND METHODS FOR USE

(71) Applicants: Murli MANOHAR, Ithaca, NY (US); Edison HIDALGO, Lincoln, PA (US); Gabriel WILMOTH, Chapel Hill, NC (US)

(72) Inventors: Murli MANOHAR, Ithaca, NY (US); Edison HIDALGO, Lincoln, PA (US); Gabriel WILMOTH, Chapel Hill, NC (US)

(21) Appl. No.: 19/498,284

(22) PCT Filed: Jun. 28, 2024
(86) PCT No.: PCT/US2024/036051

§ 371 Date: Dec. 30, 2025

Related U.S. Application Data
(60) Provisional application No. 63/511,172, filed on Jun. 29, 2023.

(51) Int. Cl. A01N 43/16; A01N 57/20; A01P 13/00

(52) U.S. Cl. CPC A01N 43/16; A01N 57/20; A01P 13/00

(57) ABSTRACT

Combinations of agents for preventing, treating, or controlling unwanted plants and methods of their use are provided. The combinations comprise at least one ascaroside (or a derivative or analog of an ascaroside) with at least one herbicide. The ascaroside can be combined with at least one herbicide to lessen the phytotoxic effects of the herbicide on the treated crop while simultaneously killing unwanted plants in the applied area. The ascarosides and herbicides may be provided in the same composition or may be applied together (i.e., substantially simultaneously) or sequentially.

### CROSS-REFERENCE TO RELATED APPLICATIONS

This application claims the benefit of priority to U.S. Provisional Appl. No. 63/511,172, filed Jun. 29, 2023, the entirety of which is hereby incorporated by reference.

### FIELD OF THE INVENTION

The invention is drawn to compositions and methods relating to use of an ascaroside and one or more herbicides.

### BACKGROUND OF THE INVENTION

Herbicides are well known to control undesired plants. Selective herbicides control specific plants and plant varieties, while non-selective herbicides kill most (if not all) plants that are contacted with the herbicide. A large percentage of herbicides are used for agricultural purposes to selectively remove unwanted plants from crop producing fields.

Selective herbicides are used frequently in crop producing fields. The selective herbicides are used to remove unwanted plants from growing in the same field that the crop producing plants (“crops”) are being grown. While herbicides can be quite selective at reducing the unwanted plants in the field, herbicides can have phytotoxic side effects on the crop plants.

### SUMMARY OF THE INVENTION

Combinations of agents for preventing, treating, or controlling unwanted plants and methods of their use are provided. The combinations comprise at least one ascaroside (or a derivative or analog of an ascaroside) with at least one herbicide. The ascaroside can be combined with at least one herbicide to lessen the phytotoxic effects of the herbicide on the treated crop while simultaneously killing unwanted plants in the applied area. The ascarosides and herbicides may be provided in the same composition or may be applied together (i.e., substantially simultaneously) or sequentially. The agents are applied in an effective amount, i.e., an amount sufficient to control or inhibit unwanted plant growth and also reduce phytotoxic side effects of the herbicides on crop plants.

### DETAILED DESCRIPTION OF THE INVENTION

The disclosure provides compositions and methods relating to use of one or more ascarosides and one or more herbicides. In some embodiments, the disclosure provides compositions and methods relating to combinations of one or more ascarosides and one or more herbicides wherein the ascaroside(s) serve the purpose of a safener to lessen phytotoxic effects of the herbicide(s) on the treated crop. As used herein, the term “ascaroside” includes the ascaroside, a derivative, an analog of the ascaroside, or combinations thereof, as will be described in further detail herein. The ascaroside can be used with any herbicide.

The ascaroside(s) and the herbicide(s) may be used in the same composition, or the ascaroside(s) and the herbicide(s) may be applied separately (e.g., in separate formulations), either simultaneously or sequentially. If applied sequentially, the applications are close enough in time such that they are able to work in combination to produce the beneficial results.

As noted, methods and compositions of the invention comprise ascarosides. Ascarosides are secondary metabolites produced by nematodes. Many structurally diverse ascarosides have been identified in nature and are believed to function as an evolutionarily conserved chemical language used by nematodes to control many aspects of their development.

Ascarosides are derivatives of the sugar ascarylose—a di-deoxy sugar lacking hydroxyl groups at its 3- and 6-positions. Ascarosides have the general structure shown in Formula I:

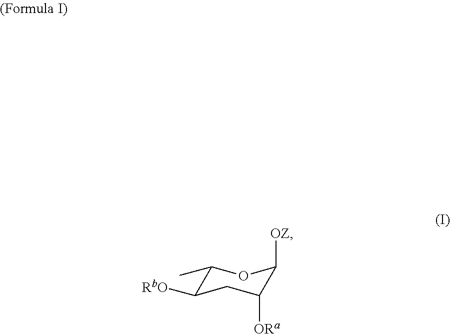

wherein:
Z is an optionally substituted C₂₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{c}), a C₂₋₂₀ carbamate (e.g. -a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule, where each R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

In certain embodiments, Z is:
(i) —CH(CH₃)—R¹, where R¹ is an optionally substituted C₁₋₄₀ aliphatic group
(ii) —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iii) —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iv) —CH(CH₃)—(CH₂)ₙ—CH(OH)—CH₂—CO₂R², where n is an integer from 1 to 40, and R² is —H, a metal cation, an optionally substituted C₁₋₂₀ aliphatic group, an optionally optionally substituted heteroaryl group, a glycoside, an amino acid, a peptide, a nucleotide, or a linkage via a bond or a carbon-containing linker moiety to another ascaroside molecule;
(v) —CH(CH₃)—(CH₂)ₙ—C(O)—CH₂—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vi) —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vii) —(CH₂)ₙ—CH—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(viii) —(CH₂)ₙ—CH(OH)—CH₂—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; or
(ix) —(CH₂)ₙ—C(O)—CH₂—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule.

In certain embodiments, Z is:
(x) —CH(CH₃)—(CH₂)ₙ—CON(R³)₂, where n is an integer from 1 to 40, and each R³ is independently —H, an optionally substituted C₁₋₂₀ aliphatic group, an optionally optionally substituted heteroaryl group, a polymer chain, an amino acid, a peptide, a nucleotide, or a linkage via a bond or a carbon-containing linker moiety to another ascaroside molecule;
(xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xii) —CH(CH₃)—(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiii) —CH(CH₃)—(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xv) —(CH₂)ₙ—CH—CH—CON(R³)₂, where n is an integer from 1 to 40, and each R³ is independently —H, an optionally substituted C₁₋₂₀ aliphatic group, an optionally optionally substituted heteroaryl group, a polymer chain, an amino acid, a peptide, a nucleotide, or a linkage via a bond or a carbon-containing linker moiety to another ascaroside molecule;
(xvi) —(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xvii) —(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
(xviii) an optionally unsaturated, optionally substituted C₂₋₄₀ sidechain terminating in a chain end comprising a nitrogen-, oxygen- or sulfur-containing functional group.

As defined above and described herein, in some embodiments, Z comprises a nitrogen-, oxygen-, or sulfur-containing functional group. It will be appreciated that “an oxygen-containing functional group” refers to moieties that comprise one or more oxygen atoms (e.g., carbonyl-containing groups such as esters, aldehydes, carboxylic acids, and ketones; ethers, hydroxyls, and heterocyclic rings comprising one or more oxygen atoms and/or one of the foregoing functional groups); “a nitrogen-containing functional group” refers to moieties that comprise one or more nitrogen atoms (e.g., amines, amides, carbamates, imines, ureas, oximes, amidines, guanidines, nitriles, azo groups, azides, and heterocyclic rings comprising one or more nitrogen atoms and/or one of the foregoing functional groups); and “a sulfur-containing functional group” refers to moieties that comprise one or more sulfur atoms (e.g., thioether, sulfone, sulfonic acid, sulfoxide, thiol, thiocyanate, or disulfide).

In some embodiments, Z is an optionally unsaturated, optionally substituted C₂₋₄₀ sidechain terminating in a chain end comprising an oxygen-containing functional group. In certain embodiments, Z is an optionally unsaturated, optionally substituted C₂₋₄₀ sidechain terminating in a chain end comprising a carboxylic acid. In certain embodiments, Z is an optionally unsaturated, optionally substituted C₂₋₄₀ sidechain terminating in a chain end comprising an aldehyde. In certain embodiments, Z is an optionally unsaturated, optionally substituted C₂₋₄₀ sidechain terminating in a chain end comprising an ester. In some embodiments, Z an optionally unsaturated, optionally substituted C₂₋₄₀ sidechain terminating in a chain end comprising —CO₂R². In some embodiments, Z is an optionally unsaturated, optionally substituted C₂₋₄₀ sidechain terminating in a chain end comprising —CO₂H. In some embodiments, Z is an optionally unsaturated, optionally substituted C₂₋₄₀ sidechain terminating in a chain end comprising —CO₂CH₃. In some embodiments, Z is an optionally unsaturated, optionally substituted C₂₋₄₀ sidechain terminating in a chain end comprising —CON(R³)₂. In some embodiments, Z is an optionally unsaturated, optionally substituted C₂₋₄₀ sidechain terminating in a chain end comprising-N(R³)₂. In some embodiments, Z is an optionally unsaturated, optionally substituted C₂₋₄₀ sidechain terminating in a chain end comprising an ester comprising a linker moiety covalently attached to one or more additional ascaroside molecules.

As described above, the ascarylose sugar moiety in the provided compounds can be substituted or unsubstituted (i.e., there can be functional groups other than −OH at 2- and 4-positions of the sugar or, stated differently, variables R^{a} and/or R^{b} can be other than −H in any of the formulae herein).

As defined above and described herein, each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g., -a moiety —C(O)OR^{c}), a C₂₋₂₀ carbamate (e.g., -a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to an ascaroside molecule.

In certain embodiments, R^{a} is —H. In certain embodiments, R^{b} is —H. In certain embodiments, R^{a} and R^{b} are the same. In certain embodiments R^{a} and R^{b} are both —H. In certain embodiments, R^{a} and R^{b} are different. In certain embodiments, R^{a} is —H, and R^{b} is other than −H. In certain embodiments, R^{a} is other than −H and R^{b} is —H. In certain embodiments, R^{a} is —H and R^{b} is p-hydroxybenzoate. In certain embodiments, R^{a} is —H and R^{b} is indole-3-carboxylate. In certain embodiments, R^{a} is —H and R^{b} is (E)-2-methyl-2-butenoate. In certain embodiments, R^{a} is —H and R^{b} is picolinate. In certain embodiments, R^{a} is —H and R^{b} is nicotinate. In certain embodiments, R^{a} is —H and R^{b} is (R)-2-hydroxy-2-(4-hydroxyphenyl)ethyl)amino)-4-oxobutanoate. In certain embodiments, R^{a} is —H and R^{b} is 4-((4-hydroxyphenethyl)amino)-4-oxobutanoate. In certain embodiments, R^{a} comprises a glycoside, amino acid, a peptide, or nucleotide. In certain embodiments, R^{b} comprises a glycoside, amino acid, a peptide, or nucleotide. In certain embodiments, R^{a} comprises a linkage to a second ascaroside molecule. In certain embodiments, R^{b} comprises a linkage to an ascaroside molecule. In certain embodiments, R^{a} comprises a sugar. In certain embodiments, R^{b} comprises a sugar.

In some embodiments, R^{a} is an optionally substituted C₁₋₂₀ aliphatic. In some embodiments, R^{a} is an optionally substituted C₁₋₆ aliphatic. In some embodiments, R^{a} is C₁₋₂₀ aliphatic. In some embodiments, R^{a} is C₁₋₆ aliphatic. In some embodiments, R^{a} is methyl, ethyl, n-propyl, iso-propyl, n-butyl, isobutyl, sec-butyl, or t-butyl. In some embodiments, R^{a} is C₁₋₂₀ acyl. In some embodiments, R^{a} is —C(O)R^{c}. In some embodiments, R^{a} is —C(O)H. In some embodiments, R^{a} is —C(O)CH₃. In some embodiments, R^{a} is an optionally substituted C₁₋₂₀ heteroaliphatic. In some embodiments, R^{a} is an optionally substituted C₁₋₆ heteroaliphatic. In some embodiments, R^{a} is C₁₋₂₀ heteroaliphatic. In some embodiments, R^{a} is C₁₋₆ heteroaliphatic. In some embodiments, R^{a} is an optionally substituted 3- and 8-membered saturated or partially unsaturated heterocyclyl having 1-3 heteroatoms independently selected from nitrogen, oxygen, or sulfur. In some embodiments, R^{a} is an optionally substituted 8- and 12-membered saturated or partially unsaturated bicyclic heterocyclyl having 1-4 heteroatoms independently selected from nitrogen, oxygen, or sulfur. In some embodiments, R^{a} is optionally substituted aryl. In some embodiments, R^{a} is optionally substituted phenyl. In some embodiments, R^{a} is phenyl. In some embodiments, R^{a} is an optionally substituted heteroaryl group. In some embodiments, R^{a} is an optionally substituted 5- to 6-membered heteroaryl having 1-3 heteroatoms independently selected from nitrogen, oxygen, or sulfur. In some embodiments, R^{a} is an optionally substituted 8- to 12-membered heteroaryl having 1-4 heteroatoms independently selected from nitrogen, oxygen, or sulfur. In some embodiments, R^{a} is an optionally substituted C₂₋₂₀ carbonate. In some embodiments, R^{a} is —C(O)OR^{c}. In some embodiments, R^{a} is an optionally substituted C₂₋₂₀ carbamate. In some embodiments, R^{a} is —C(O)N(R^{c})₂. In some embodiments, R^{a} is an optionally substituted C₂₋₂₀ thioester. In some embodiments, R^{a} is —C(S)R^{c}. In some embodiments, R^{a} is an optionally substituted C₂₋₂₀ thiocarbonate. In some embodiments, R^{a} is —C(S)OR^{c}. In some embodiments, R^{a} is an optionally substituted C₂₋₂₀ dithiocarbonate. In some embodiments, R^{a} is —C(S)SR^{c}. In some embodiments, R^{a} is an optionally substituted C₁₋₂₀ thiocarbamate. In some embodiments, R^{a} is —C(S)N(R^{c})₂.

In some embodiments, R^{a} is an optionally substituted hydroxyl protecting group. Suitable hydroxyl protecting groups are well known in the art and include those described in detail in Protecting Groups in Organic Synthesis, T. W. Greene and P. G. M. Wuts, 3^{rd} edition, John Wiley & Sons, 1999. Examples of suitable oxygen protecting groups include, but are not limited to, acetyl, benzoyl benzyl, β-methoxyethoxymethyl ether (MEM), dimethoxytrityl (DMT), methoxymethyl ether (MOM), methoxytrityl (MMT), p-methoxybenzyl ether (PMB), methylthiomethyl ether, pivaloyl, tetrahydropyranyl (THP), tetrahydrofuran (THF), trityl, silyl ethers (e.g., trimethylsilyl (TMS), tert-butyldimethylsilyl (TBDMS), tri-iso-propylsilyloxymethyl (TOM), and triisopropylsilyl (TIPS) ethers), methyl ethers, and ethoxyethyl ethers. In some embodiments, R^{a} is —OR^{c}.

In some embodiments, R^{a} is an optionally substituted phosphorous-linked functional group. It will be appreciated that “phosphorous-linked functional group” as used herein refers to moieties that comprise one or more phosphorous atoms (e.g., phosphine, phosphodiester, phosphonic acid, phosphate). In some embodiments, R^{a} is an optionally substituted sulfur-linked functional group. It will be appreciated that “sulfur-linked functional group” as used herein refers to moieties that comprise one or more sulfur atoms (e.g., thioether, sulfone, sulfonic acid, sulfoxide, thiol, thiocyanate, or disulfide). In some embodiments, R^{a} is an optionally substituted silicon-linked functional group. It will be appreciated that “silicon-linked functional group” as used herein refers to moieties that comprise one or more silicon atoms (e.g., silanol, suloxides, siloxanes, silyl ethers, silyl chlorides, silyl hydrides, silenes, or siloles).

In some embodiments, R^{a} is an optionally substituted sugar moiety. In some embodiments, R^{a} is an optionally substituted peptide. In some embodiments, R^{a} is an optionally substituted polymer chain. In some embodiments, R^{a} is a linkage via a bond or a carbon-containing linker moiety to an ascaroside molecule. In some embodiments, R^{a} is an optionally substituted C₁₋₆ aliphatic or heteroaliphatic comprising an ascaroside.

In some embodiments, R^{b} is an optionally substituted C₁₋₂₀ aliphatic. In some embodiments, R^{b} is an optionally substituted C₁₋₆ aliphatic. In some embodiments, R^{b} is C₁₋₂₀ aliphatic. In some embodiments, R^{b} is C₁₋₆ aliphatic. In some embodiments, R^{b} is methyl, ethyl, n-propyl, iso-propyl, n-butyl, isobutyl, sec-butyl, or t-butyl. In some embodiments, R^{b} is C₁₋₂₀ acyl. In some embodiments, R^{b} is —C(O)R^{c}. In some embodiments, R^{b} is —C(O)H. In some embodiments, R^{b} is —C(O)CH₃. In some embodiments, R^{b} is an optionally substituted C₁₋₂₀ heteroaliphatic. In some embodiments, R^{b} is an optionally substituted C₁₋₆ heteroaliphatic. In some embodiments, R^{b} is C₁₋₂₀ heteroaliphatic. In some embodiments, R^{b} is C₁₋₆ heteroaliphatic. In some embodiments, R^{b} is an optionally substituted 3- and 8-membered saturated or partially unsaturated heterocyclyl having 1-3 heteroatoms independently selected from nitrogen, oxygen, or sulfur. In some embodiments, R^{b} is an optionally substituted 8- and 12-membered saturated or partially unsaturated bicyclic heterocyclyl having 1-4 heteroatoms independently selected from nitrogen, oxygen, or sulfur. In some embodiments, R^{b} is optionally substituted aryl. In some embodiments, R^{b} is optionally substituted phenyl. In some embodiments, R^{b} is phenyl. In some embodiments, R^{b} is an optionally substituted heteroaryl group. In some embodiments, R^{b} is an optionally substituted 5- to 6-membered heteroaryl having 1-3 heteroatoms independently selected from nitrogen, oxygen, or sulfur. In some embodiments, R^{b} is an optionally substituted 8- to 12-membered heteroaryl having 1-4 heteroatoms independently selected from nitrogen, oxygen, or sulfur. In some embodiments, R^{b} is an optionally substituted C₂₋₂₀ carbonate. In some embodiments, R^{b} is —C(O)OR^{c}. In some embodiments, R^{b} is an optionally substituted C₂₋₂₀ carbamate. In some embodiments, R^{b} is —C(O)N(R^{c})₂. In some embodiments, R^{b} is an optionally substituted C₂₋₂₀ thioester. In some embodiments, R^{b} is —C(S)R^{c}. In some embodiments, R^{b} is an optionally substituted C₂₋₂₀ thiocarbonate. In some embodiments, R^{b} is —C(S)OR^{c}. In some embodiments, R^{b} is an optionally substituted C₂₋₂₀ dithiocarbonate. In some embodiments, R^{b} is —C(S)SR^{c}. In some embodiments, R^{a} is an optionally substituted C₁₋₂₀ thiocarbamate. In some embodiments, R^{b} is —C(S)N(R^{c})₂.

In some embodiments, R^{b} is an optionally substituted hydroxyl protecting group. In some embodiments, R^{b} is —OR^{c}.

In some embodiments, R^{b} is an optionally substituted phosphorous-linked functional group. In some embodiments, R^{b} is an optionally substituted sulfur-linked functional group. In some embodiments, R^{b} is an optionally substituted silicon-linked functional group.

In some embodiments, R^{b} is an optionally substituted sugar moiety. In some embodiments, R^{a} is an optionally substituted peptide. In some embodiments, R^{b} is an optionally substituted polymer chain. In some embodiments, R^{b} is a linkage via a bond or a carbon-containing linker moiety to an ascaroside molecule. In some embodiments, R^{b} is an optionally substituted C₁₋₆ aliphatic or heteroaliphatic comprising an ascaroside.

In some embodiments, R^{a} and R^{b} may be taken together to form an optionally substituted ring, optionally containing one or more heteroatoms, and optionally containing one or more sites of unsaturation. In some embodiments, R^{a} and R^{b} may be taken together to form an optionally substituted 3- to 12-membered monocyclic or bicyclic saturated or partially unsaturated carbocyclyl or heterocyclyl ring having 1-4 heteroatoms independently selected from nitrogen, oxygen, or sulfur. In some embodiments, R^{a} and R^{b} may be taken together to form an optionally substituted 5- to 12-membered monocyclic or bicyclic aryl or heteroaryl ring having 1-4 heteroatoms independently selected from nitrogen, oxygen, or sulfur.

In certain embodiments, R^{a} and R^{b} are the same. In certain embodiments R^{a} and R^{b} are both —H.

In certain embodiments, R^{a} and R^{b} are different. In certain embodiments, R^{a} is —H, and R^{b} is other than −H. In certain embodiments, R^{a} is other than −H and R^{b} is —H. In certain embodiments, R^{a} is —H and R^{b} is p-hydroxybenzoate. In certain embodiments, R^{a} is —H and R^{b} is indole-3-carboxylate. In certain embodiments, R^{a} is —H and R^{b} is (E)-2-methyl-2-butenoate. In certain embodiments, R^{a} is —H and R^{b} is picolinate. In certain embodiments, R^{a} is —H and R^{b} is nicotinate. In certain embodiments, R^{a} is —H and R^{b} is (R)-2-hydroxy-2-(4-hydroxyphenyl)ethyl)amino)-4-oxobutanoate. In certain embodiments, R^{a} is —H and R^{b} is 4-((4-hydroxyphenethyl)amino)-4-oxobutanoate.

As defined above and described herein, each Reis independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule.

In some embodiments, R^{c} is independently at each occurrence selected from —H, optionally substituted C₁₋₁₂ aliphatic, optionally substituted C₁₋₁₂ heteroaliphatic, optionally substituted aryl, optionally substituted heteroaryl.

In some embodiments, an occurrence of R^{c} is —H. In some embodiments, R^{c} is an optionally substituted C₁₋₁₂ aliphatic group. In some embodiments, R^{c} is an optionally substituted C₁₋₆ aliphatic group. In some embodiments, R^{c} is an optionally substituted C₁₋₁₂ heteroaliphatic group. In some embodiments, R^{c} is an optionally substituted C₁₋₆ heteroaliphatic group. In some embodiments, R^{c} is an optionally substituted 3- and 8-membered saturated or partially unsaturated heterocyclyl having 1-3 heteroatoms independently selected from nitrogen, oxygen, or sulfur. In some embodiments, R^{c} is an optionally substituted 8- and 12-membered saturated or partially unsaturated bicyclic heterocyclyl having 1-4 heteroatoms independently selected from nitrogen, oxygen, or sulfur. In some embodiments, R^{c} is an optionally substituted aryl group. In some embodiments, R^{c} is optionally substituted phenyl. In some embodiments, R² is phenyl. In some embodiments, R^{c} is an optionally substituted heteroaryl group. In some embodiments, R^{c} is an optionally substituted 5- to 6-membered heteroaryl having 1-3 heteroatoms independently selected from nitrogen, oxygen, or sulfur. In some embodiments, R^{c} is an optionally substituted 8- to 12-membered heteroaryl having 1-4 heteroatoms independently selected from nitrogen, oxygen, or sulfur.

In certain embodiments R^{a} and R^{b} are both —H, and Z is selected from the formulae defined in (i) to (ix) above. In certain embodiments R^{a} and R^{b} are both —H, and Z conforms to formula (i) above. In certain embodiments R^{a} and R^{b} are both —H, and Z conforms to formula (ii) above. In certain embodiments R^{a} and R^{b} are both —H, and Z conforms to formula (iii) above. In certain embodiments R^{a} and R^{b} are both —H, and Z conforms to formula (iv) above. In certain embodiments R^{a} and R^{b} are both —H, and Z conforms to formula (v) above. In certain embodiments R^{a} and R^{b} are both —H, and Z conforms to formula (vi) above. In certain embodiments R^{a} and R^{b} are both —H, and Z conforms to formula (vii) above. In certain embodiments R^{a} and R^{b} are both —H, and Z conforms to formula (viii) above. In certain embodiments R^{a} and R^{b} are both —H, and Z conforms to formula (ix) above. In certain embodiments R^{a} and R^{b} are both —H, and Z conforms to formula (x) above. In certain embodiments R^{a} and R^{b} are both —H, and Z conforms to formula (xi) above. In certain embodiments R^{a} and R^{b} are both —H, and Z conforms to formula (xii) above. In certain embodiments R^{a} and R^{b} are both —H, and Z conforms to formula (xiii) above. In certain embodiments R^{a} and R^{b} are both —H, and Z conforms to formula (xiv) above. In certain embodiments R^{a} and R^{b} are both —H, and Z conforms to formula (xv) above. In certain embodiments R^{a} and R^{b} are both —H, and Z conforms to formula (xvi) above. In certain embodiments R^{a} and R^{b} are both —H, and Z conforms to formula (xvii) above.

As defined above and described herein, R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule. In some embodiments, R² is —H, an optionally substituted C₁₋₂₀ aliphatic group, an optionally substituted C₁₋₂₀ heteroaliphatic group, or an optionally substituted aryl group, an optionally substituted heteroaryl group.

In certain embodiments, R² is —H. In certain embodiments, R² is a metal cation. In certain embodiments, R² is an organic cation (e.g. a nitrogen or phosphorous centered cationic group). In certain embodiments, R² is an optionally substituted C₁₋₂₀ aliphatic group. In certain embodiments, R² is an optionally substituted C₁₋₁₂ aliphatic group. In certain embodiments, R² is an optionally substituted C₁₋₈ aliphatic group. In certain embodiments, R² is an optionally substituted C₁₋₆ aliphatic group. In certain embodiments, R² is selected from methyl, ethyl, n-propyl, i-propyl, n-butyl, sec-butyl, and t-butyl. In some embodiments, R² is an optionally substituted C₁₋₂₀ heteroaliphatic group. In some embodiments, R² is an optionally substituted C₁₋₆ heteroaliphatic group. In some embodiments, R² is an optionally substituted 3- and 8-membered saturated or partially unsaturated heterocyclyl having 1-3 heteroatoms independently selected from nitrogen, oxygen, or sulfur. In some embodiments, R² is an optionally substituted 8- and 12-membered saturated or partially unsaturated bicyclic heterocyclyl having 1-4 heteroatoms independently selected from nitrogen, oxygen, or sulfur. In certain embodiments, R² is an optionally substituted aromatic group. In some embodiments, R² is optionally substituted phenyl. In some embodiments, R² is phenyl. In some embodiments, R² is an optionally substituted heteroaryl group. In some embodiments, R² is an optionally substituted 5- to 6-membered heteroaryl having 1-3 heteroatoms independently selected from nitrogen, oxygen, or sulfur. In some embodiments, R² is an optionally substituted 8- to 12-membered heteroaryl having 1-4 heteroatoms independently selected from nitrogen, oxygen, or sulfur.

In certain embodiments, R² is a glycoside. It will be appreciated that a glycoside refers to a moiety comprising a sugar bound to another functional group via a glycosidic bond.

In certain embodiments, R² comprises an amino acid. In certain embodiments, R² comprises a peptide. In some embodiments, R² is nucleotide. In some embodiments, R² is adenosine monophosphate, cytidine monophosphate, guanosine monophosphate, or uridine monophosphate. In some embodiments, R² is deoxyadenosine monophosphate, deoxycytidine monophosphate, deoxyguanosine monophosphate, or deoxythymidine monophosphate.

In some embodiments, R² is a linkage via a bond or a carbon-containing linker moiety to another ascaroside molecule. In some embodiments, R² is an optionally substituted C₁₋₆ aliphatic or heteroaliphatic comprising an ascaroside.

As defined above and described herein, each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule, and where both R³ groups can be taken together to form an optionally substituted, optionally unsaturated ring optionally containing one or more additional heteroatoms.

In some embodiments, each R³ is independently selected from —H and C₁₋₈ aliphatic. In some embodiments, one R³ is —H and the other R³ is other than −H. In some embodiments, neither R³ is —H. In certain embodiments, at least one R³ is —H. In certain embodiments, both R³ groups are —H. In certain embodiments, at least one R³ is an optionally substituted C₁₋₂₀ aliphatic group. In some embodiments, an occurrence of R³ is an optionally substituted C₁₋₂₀ aliphatic group. In some embodiments, an occurrence of R³ is an optionally substituted C₁₋₆ aliphatic group. In certain embodiments, both R³ groups are an optionally substituted C₁₋₂₀ aliphatic group which may be the same or different. In certain embodiments, at least one R³ is an optionally substituted C₁₋₁₂ aliphatic group. In certain embodiments, at least one R³ is an optionally substituted C₁₋₈ aliphatic group. In certain embodiments, at least one R³ is an optionally substituted C₁₋₆ aliphatic group. In certain embodiments, at least one R³ is selected from methyl, ethyl, n-propyl, i-propyl, n-butyl, sec-butyl, and t-butyl. In certain embodiments, at least one R³ is —CH₂CH₂OH. In certain embodiments, at least one R³ is —CH₂CH₂OR².

In some embodiments, an occurrence of R³ is an optionally substituted C₁₋₂₀ heteroaliphatic group. In some embodiments, an occurrence of R³ is an optionally substituted C₁₋₆ heteroaliphatic group. In some embodiments, R³ is an optionally substituted 3- and 8-membered saturated or partially unsaturated heterocyclyl having 1-3 heteroatoms independently selected from nitrogen, oxygen, or sulfur. In some embodiments, R³ is an optionally substituted 8- and 12-membered saturated or partially unsaturated bicyclic heterocyclyl having 1-4 heteroatoms independently selected from nitrogen, oxygen, or sulfur. In some embodiments, occurrence of R³ is an optionally substituted aromatic group. In some embodiments, R³ is optionally substituted phenyl. In some embodiments, R³ is phenyl. In some embodiments, R³ is an optionally substituted heteroaryl group. In some embodiments, R³ is an optionally substituted 5- to 6-membered heteroaryl having 1-3 heteroatoms independently selected from nitrogen, oxygen, or sulfur. In some embodiments, R³ is an optionally substituted 8- to 12-membered heteroaryl having 1-4 heteroatoms independently selected from nitrogen, oxygen, or sulfur. In certain embodiments, at least one R³ is an optionally substituted aromatic group. In certain embodiments, at least one R³ comprises a glycoside. In certain embodiments, at least one R³ comprises an amino acid. In certain embodiments, at least one R³ at least one R³ comprises a peptide. In certain embodiments, at least one R³ comprises a nucleotide.

In certain embodiments, an ascaroside is selected from the group consisting of:

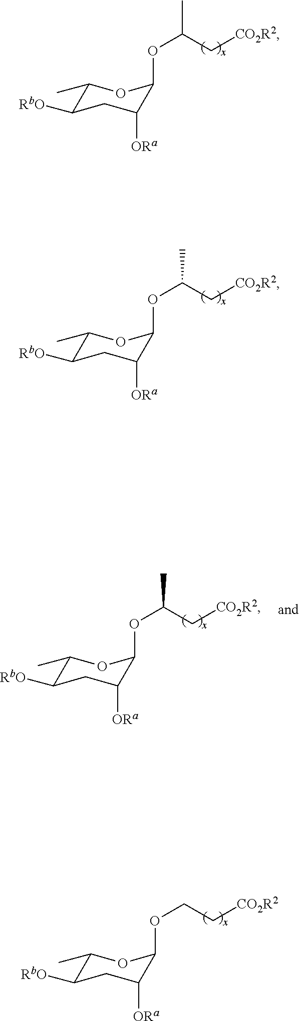

where x is an integer from 1 to 22, and each of R^{a}, R^{b}, and R² is as defined above and in the genera and subgenera herein.

In certain embodiments, an ascaroside is selected from the group consisting of:

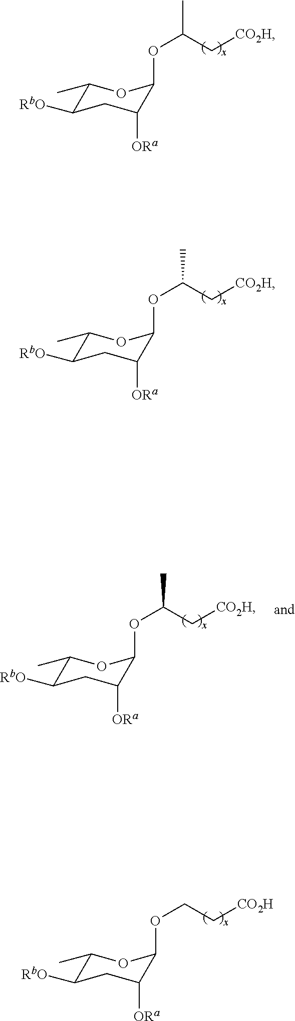

where each of x, R^{a}, and R^{b}, is as defined above and in the genera and subgenera herein.

In certain embodiments, an ascaroside is selected from the group consisting of:

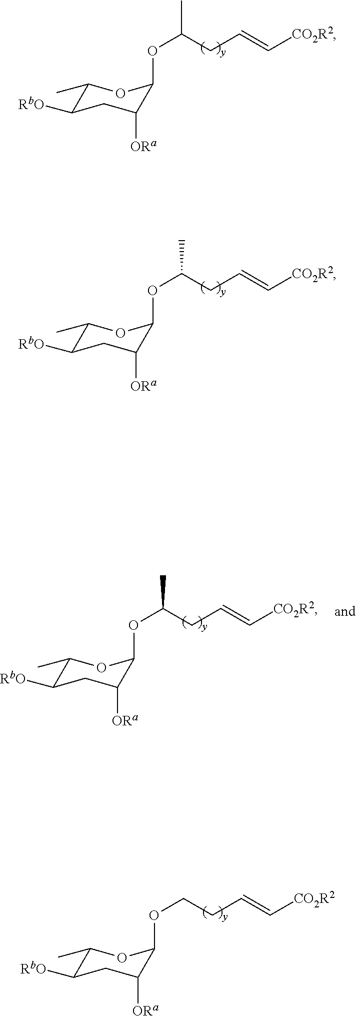

where y is an integer from 1 to 20, and each of R^{a}, R^{b}, and R² is as defined above and in the genera and subgenera herein.

In certain embodiments, an ascaroside is selected from the group consisting of:

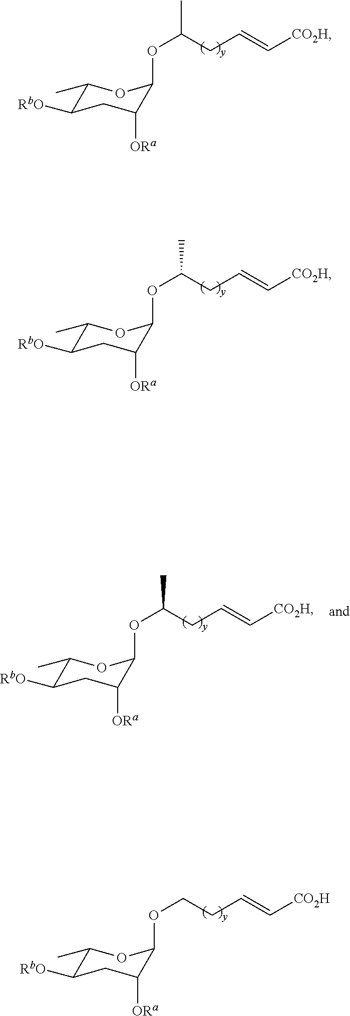

where each of y, R^{a}, and R^{b}, is as defined above and in the genera and subgenera herein.

In certain embodiments, an ascaroside is selected from the group consisting of:

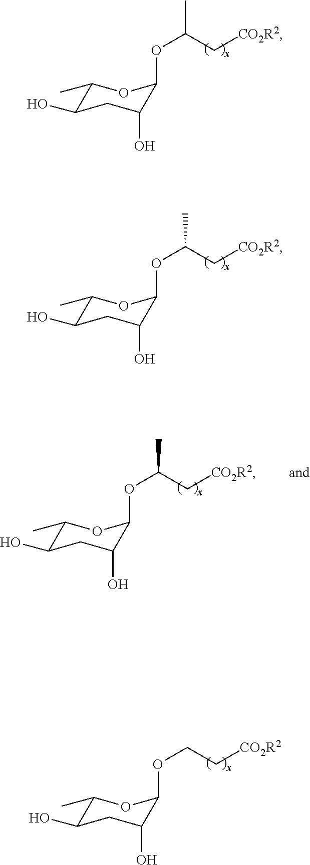

where each of x and R² is as defined above and in the genera and subgenera herein.

In certain embodiments, an ascaroside is selected from the group consisting of:

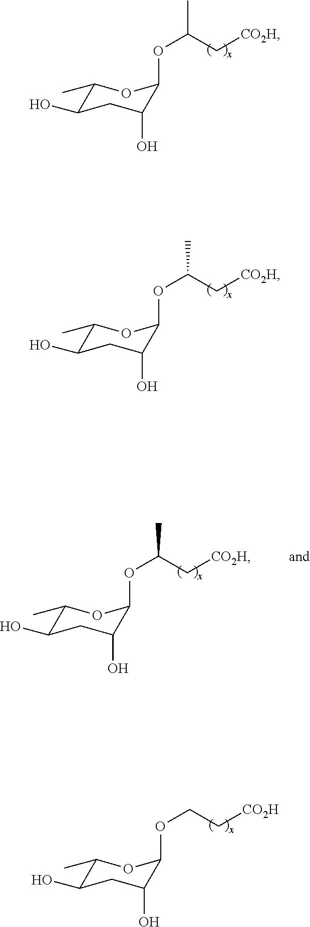

where x is as defined above and in the genera and subgenera herein.

In certain embodiments, an ascaroside is selected from the group consisting of:

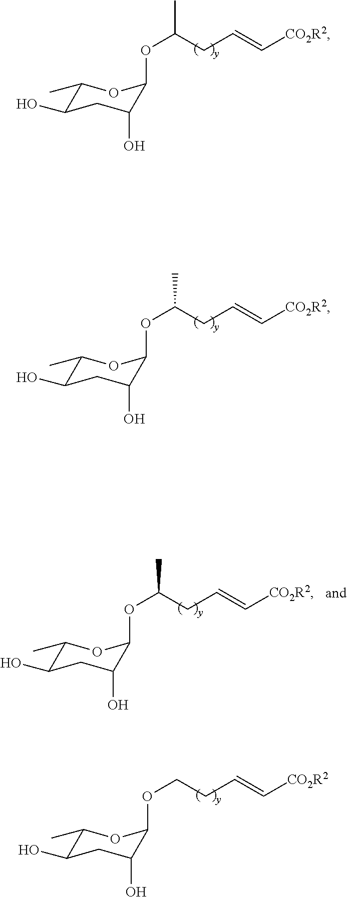

where y is an integer from 1 to 20, and R² is as defined above and in the genera and subgenera herein.

In certain embodiments, an ascaroside is selected from the group consisting of:

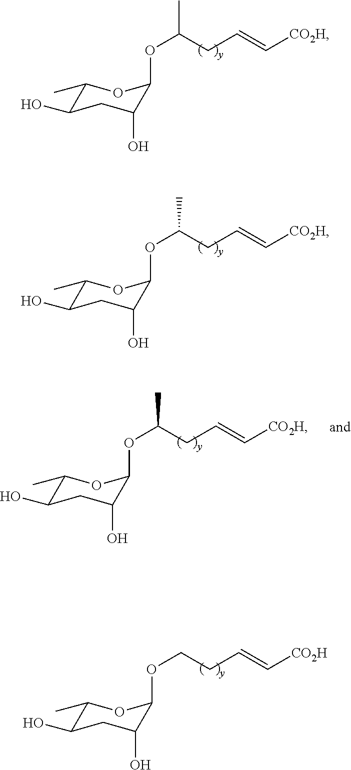

where y is as defined above and in the genera and subgenera herein.

In certain embodiments, an ascaroside is selected from the group consisting of:

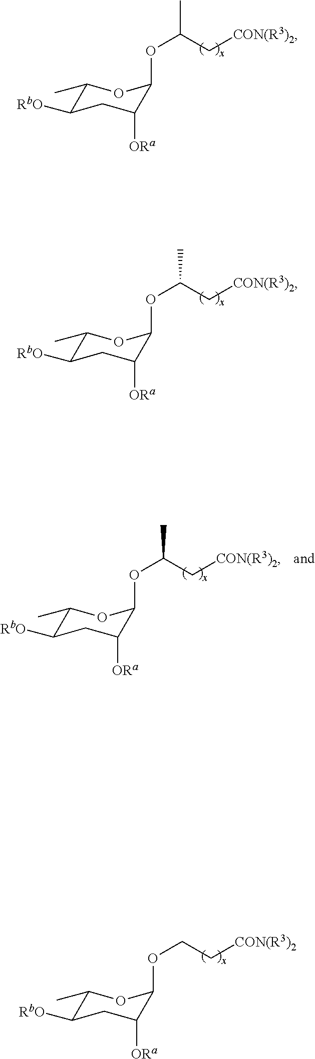

where each of x, R^{a}, R^{b}, and R³ is as defined above and in the genera and subgenera herein.

In certain embodiments, an ascaroside is selected from the group consisting of:

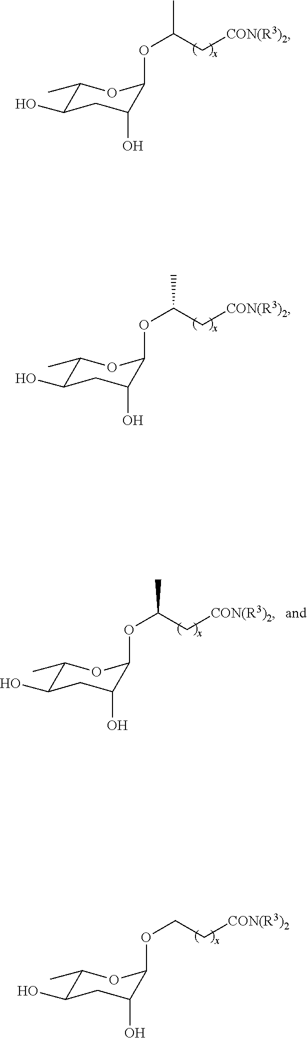

where each of x and R³ is as defined above and in the genera and subgenera herein.

In certain embodiments, an ascaroside is selected from the group consisting of:

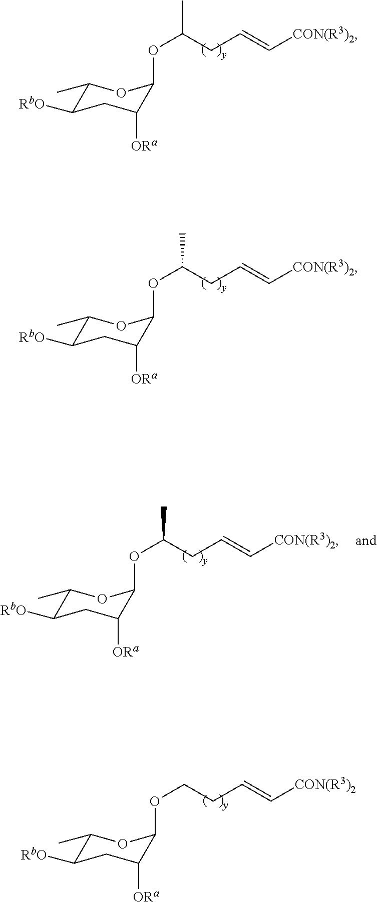

where each of y, R^{a}, R^{b}, and R³ is as defined above and in the genera and subgenera herein.

In certain embodiments, an ascaroside is selected from the group consisting of:

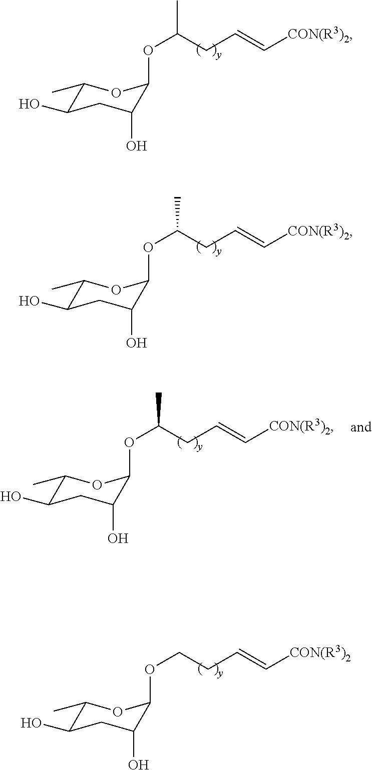

where each of y and R³ is as defined above and in the genera and subgenera herein.

In an embodiment, ascarosides useful in the context of the present disclosure have the general structure (I), where Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

In an embodiment, ascarosides useful in the context of the present disclosure have the general structure (I) where Z is —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

Specific ascarosides that are useful in the context of the present disclosure include, but are not limited to, ascr #7 and ascr #18.

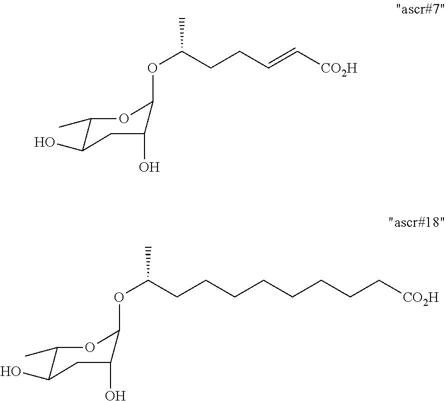 [SMILES: CC1OC(O[C@H](C)CC/C=C/C(=O)O)C(O)CC1O ; CC1OC(O[C@H](C)CCCCCCCCC(=O)O)C(O)CC1O]

In certain embodiments, an ascaroside used in the provided methods and compositions is selected from the group consisting of: ascr #9, ascr #12, ascr #14, ascr #1, ascr #10, ascr #16, ascr #18, ascr #20, ascr #22, ascr #24, ascr #26, ascr #28, ascr #30, ascr #32, ascr #34, and ascr #36. In certain embodiments, an ascaroside used in the provided methods is selected from the group consisting of: ascr #10, ascr #16, ascr #18, ascr #20, ascr #22, and ascr #24. In certain embodiments, an ascaroside used in the provided methods is selected from the group consisting of: ascr #9, ascr #14, ascr #10, and ascr #18.

In certain embodiments, an ascaroside used in the provided methods and compositions is selected from the group consisting of: ascr #5, oscr #9, oscr #12, oscr #1, oscr #14, oscr #10, oscr #16, oscr #18, oscr #20, oscr #22, oscr #24, oscr #26, oscr #28, oscr #30, oscr #32, oscr #34, and oscr #36. In certain embodiments, an ascaroside used in the provided methods is selected from the group consisting of: oscr #10, oscr #16, oscr #18, oscr #20, and oscr #22. In certain embodiments, an ascaroside used in the provided methods is selected from the group consisting of: bhas #5, oscr #9, oscr #12, oscr #1, oscr #14, oscr #10, oscr #16, oscr #18, oscr #20, oscr #22, oscr #24, oscr #26, oscr #28, oscr #30, oscr #32, oscr #34, and oscr #36. In certain embodiments, an ascaroside used in the provided methods is selected from the group consisting of: oscr #10, oscr #16, oscr #18, oscr #20, and oscr #22.

In certain embodiments, an ascaroside used in the provided methods and compositions is selected from the group consisting of: bhas #9, bhas #10, bhas #16, bhas #18, bhas #22, bhas #24, bhas #26, bhas #28, bhas #30, bhas #32, bhas #34, bhas #36, bhas #38, bhas #40, and bhas #42.

In certain embodiments, an ascaroside used in the provided methods and compositions is selected from the group consisting of: bhos #10, bhos #16, bhos #18, bhos #22, bhos #24, bhos #26, bhos #28, bhos #30, bhos #32, bhos #34, bhos #36, bhos #38, bhos #40, and bhos #42.

In certain embodiments, an ascaroside used in the provided methods and compositions is selected from the group consisting of: ascr #18, oscr #16, oscr #17, oscr #15, bhas #18, bhos #16, glas #18, dhas #18, ibha #18, ibho #16, icas #18, icos #15, icos #16, and any combination of two or more of these.

Ascarosides can be obtained from natural sources (e.g., nematodes) or they may be prepared synthetically. Ascarosides can be prepared synthetically, for example, by converting 1-O-substituted rhamnose to 1-O-substituted ascarylose. An exemplary method of preparing ascarosides includes: providing as a feedstock a 1-O-substituted rhamnose; forming a mono-sulfonate ester at the 3-OH group of the feedstock; and treating the mono-sulfonate ester with a hydride source to form a 1-O-substituted ascarylose. In certain embodiments, forming the mono-sulfonate ester is conducted on a substrate without hydroxyl protecting groups at the 2- or 4-position of the rhamnose feedstock. In certain embodiments, such methods comprise contacting the feedstock with a sulfonating agent (i.e., a sulfonyl halide, sulfonic anhydride or similar reagent) in the presence of a Lewis acid. Specific details regarding the synthesis of 1-O-substituted ascarylose can be found in international publication No. WO 2022/024067, which is incorporated herein by reference.

As indicated, according to the present disclosure, ascarosides can be used in combination with herbicides as a safener to lessen phytotoxic effects of the herbicide on the treated crop. Herbicides work by affecting a variety of biological processes associated with plants. Exemplary classes of herbicides that can be used in combination with ascarosides include, but are not limited to: PPO Herbicides; Auxin Herbicides, ALS/AHAS Herbicides; ACCase Inhibitor Herbicides; Carotenoid Biosynthesis Inhibitor Herbicides; Cellulose Inhibitor Herbicides; EPSP Inhibitor Herbicides; Glutamine Synthesis Inhibitor Herbicides; Lipid Synthesis Inhibitor Herbicides; Microtubule Assembly Inhibitor Herbicides; and Photosystem Inhibitor Herbicides.

PPO Herbicides inhibit protoporphyrinogen oxidase enzyme (PPO). PPO controls the conversion of protoporphyrinogen IX to protoporphyrin IX. The result of inhibiting PPO is accumulation of singlet oxygen in the presence of light. This leads to a light-induced breakdown of cell components, which results in cell leakage, inhibited photosynthesis, and finally bleaching of chloroplast pigments. Exemplary PPO Herbicides include, but are not limited to, aclonifen, acifluorfen, bifenox, butafenacil, flumioxazin, fomesafen, oxyfluorfen, oxadiazon, saflufenacil, and sulfentrazone.

Auxin Herbicides are compounds that mimic auxin, a plant hormone that regulates many aspects of growth. Auxin herbicides bind to hormone receptors in plant cells leading to the disruption of several growth processes in susceptible plants. Exemplary Auxin Herbicides include, but are not limited to, aminopyralid, aminocyclopyrachlor, 4-(4-chloro-o-tolyloxy)butyric acid (MCPB), clopyralid, dicamba, diflufenzopyr, 2,4-dichlorophenoxyacetic acid (2,4-D), 4-(2,4-dichlorophenoxy)butyric acid (2,4-DB), fluroxypyr, mecoprop, 2-methyl-4-chlorophenoxyacetic acid (MCPA), picloram, quinclorac, 2,4,5-trichlorophenoxyacetic acid (2,4,5-T), and triclopyr. ALS/AHAS Herbicides acts as inhibitors of acetolactate synthase (ALS), also called acetohydroxyacid synthase (AHAS), which is a key enzyme in the pathway of biosynthesis of the branched-chain amino acids isoleucine, leucine, and valine. Exemplary ALS/AHAS herbicides include, but are not limited to, bensulfuron, chlorimuron, cloransulam, chlorsulfuron, diclosulam, flazasulfuram, florasulam, flucarbazone, flumetsulam, foramsulfuron, halosulfuron, imazamethabenz, imazamox, imazapic, imazapyr, imazaquin, imazethapyr, mesosulfuron, metsulfuron, nicosulfuron, penoxsulam, primisulfuron, propoxycarbazone, prosulfuron, pyrithiobac, pyroxsulam, rimsulfuron, sulfometuron, sulfosulfuron, thifensulfuron, triasulfuron, tribenuron, trifloxysulfuron, and triflusulfuron.

ACCase Inhibitor Herbicides inhibit the enzyme acetyl-CoA carboxylase (ACCase) which, in plants, catalyzes the first step in fatty acid synthesis and is important for membrane synthesis. Exemplary ACCase Inhibitor Herbicides include, but are not limited to, butroxydim, clethodim, cyhalofop, diclofop, fenoxaprop, fluazifop, haloxyfop, pinoxaden, quizalofop, sethoxydim, and tralkoxydim.

Carotenoid Biosynthesis Inhibitor Herbicides interfere directly or indirectly with carotenoid production that protects chlorophyll from excessive light and photo oxidation. Exemplary Carotenoid Biosynthesis Inhibitor Herbicides include, but are not limited to, amitrole, clomazone, fluridone, isoxaflutole, mesotrione, norflurazon, pyrasulfotole, tembotrione, and topramezone.

Cellulose Inhibitor Herbicides selectively inhibit the synthesis of cellulose. Exemplary Cellulose Inhibitor Herbicides include, but are not limited to, dichlobenil, flupoxam, indaziflam, isoxaben, and quinclorac.

EPSP Herbicides are herbicides that inhibit 5-enolpyruvylshikimate-3-phosphate (EPSP) synthase, a key enzyme in the shikimic acid pathway, which is involved in the synthesis of the aromatic amino acids. EPSP inhibition leads to depletion of the aromatic amino acids tryptophan, tyrosine, and phenylalanine that are needed for protein synthesis. Glyphosate is the most widely used EPSP herbicide.

Glutamine Synthesis Inhibitor Herbicides inhibit activity of glutamine synthetase, the enzyme that converts glutamate and ammonia to glutamine. This inhibition results in massive accumulation of ammonia in a plant which destroys cells and directly inhibits photosystem I and photosystem II reactions. Glufosinate is the most widely used Glutamine Synthesis Inhibitor Herbicide.

Lipid Synthesis Inhibitor Herbicides interfere with biosynthesis of fatty acids and lipids in plants. Exemplary Lipid Synthesis Inhibitor Herbicides include, but are not limited to, acetochlor, alachlor, bensulide, benthiocarb, chloroacetamide, cycloate, dimethenamid, S-ethyl-N,N-dipropylthiocarbamate (EPTC), ethofumesate, flufenacet, metolachlor, napropamide, propachlor, and triallate.

Microtubule Assembly Inhibitor Herbicides are mitotic poisons that inhibit cell division in plants. Exemplary Microtubule Assembly Inhibitors include, but are not limited to, benefin, benfluralin, dimethyl tetrachloroterephthalate (DCPA), dithiopyr, ethalfluralin, oryzalin, pendimethalin, prodiamine, propyzamide (pronamide), thiazopyr, and trifluralin.

Photosystem Inhibitor Herbicides are compounds that interfere with photosynthesis and cellular respiration processes to kill plants. Exemplary Photosystem Inhibitor Herbicides include, but are not limited to, atrazine, diquat, diuron, linuron, metribuzin, paraquat, and simazine.

Herbicides can also be classified by chemical class. Herbicides whose phytotoxic side effects on crop plants can be reduced using ascarosides include, for example, herbicides from the group of the carbamates, thiocarbamates, haloacetanilides, substituted phenoxy-, naphthoxy- and phenoxyphenoxy carboxylic acid derivatives and heteroaryloxyphenoxyalkane carboxylic acid derivatives, such as quinolyloxy-, quinoxalyloxy-, pyridyloxy-, benzoxazolyloxy- and benzothiazolyloxyphenoxyalkane carboxylic acid esters, cyclohexanedione derivatives, imidazolinones, pyrimidinyloxypyridincarboxylic acid derivatives, pyrimidyloxybenzoic acid derivatives, sulfonylureas, triazolopyrimidinesulfonamide derivatives and S—(N-aryl-N-alkylcarbamoylmethyl)dithiophosphoric esters, hormone-type herbicides, pyridinecarboxylic acids, triazinones, triazolinones, pyridinecarboxamides, hydroxybenzonitriles, isoxazoles. Phenoxyphenoxy- and heteroaryloxyphenoxy carboxylic acid esters and salts, sulfonylureas, imidazolinones; isoxazoles and herbicides which, together with ALS inhibitors (acetolactate synthetase inhibitors), are employed for widening the activity spectrum, for example bentazone, cyanazin, atrazin, bromoxynil, dicamba and other leaf-acting herbicides. Other compounds for use in this invention, such as the herbicidal benzoylisoxazole and/or dione compounds, which are not commercially available, may be prepared by the methods described in patent publications, or by the application or adaptation of known methods used or described in the chemical literature for similar compounds.

It is recognized that additional herbicides and other plant growth regulators may be included in the methods and compositions of the invention. Other additional active agents are known in the art that can be used with the combination described herein and include fungicides, insecticides, miticides, arthropodicides, bactericides, ectoparasiticides, and the like, that are compatible with the combination of the present invention and not antagonistic to the activity of the ascaroside(s) or the herbicide(s).

In some cases, the common names are mentioned in the herbicide list. In such cases, the common name identifies the active ingredient in its commercially available form or forms including derivatives such as salts and esters, even if a specific salt or ester is not mentioned specifically (preferably in its usual commercial form).

The application of the one or more herbicides and the one or more ascarosides can be in pre- or post-emergence application. The preferred application method depends on the usual or optimal application time of the particular herbicide or herbicide combination.

The anti-pathogen activity of ascarosides provides additional benefits to the methods and composition. Advantageously, the one or more ascarosides can not only provide a reduction in the phytotoxic effects on plants commonly associated with herbicide application, but can also provide long-lasting fungicidal effect. For example, although fungicides and antibacterials are generally applied at later time points in crop growth when such pathogens are present, the present disclosure provides methods and compositions which employ application of an ascaroside at a very early time point (i.e., a time point at which herbicides are traditionally applied to crops) and can impart resistance to pathogens in the crop plants so treated. In some embodiments, although applying the ascaroside at an early stage in the plant life cycle, it surprisingly exhibits a long-lasting effect, e.g., decreasing or preventing damage caused by fungi, bacteria, viruses and molds for a period of time exceeding 3 days after application, exceeding 5 days after application, exceeding one week after application, exceeding two weeks after application, exceeding one-month after application, exceeding two-months after application, or exceeding three-months after application.

The co-application of ascarosides and herbicides early in the season can also provide important economic advantages to growers and enhance the sustainability of crop production. Co-application of ascarosides with herbicide can prevent the need for a separate fungicide treatment later in the season. This saves fuel and labor and potentially avoids the need to apply more toxic pathogen control products since ascaroside treatments can act as a preventative control that enhances crops' tolerance to a broad range of pathogens. An additional or alternate benefit of combining ascarosides with herbicide treatments is the control of early season plant pathogens such as fungi, bacteria, viruses and nematodes. Without being bound to a particular theory, co-application of ascarosides with herbicide can prevent the need for a separate early season fungicide which saves fuel and labor and potentially avoids the need to apply more toxic pathogen control products since ascaroside treatments can act as a preventative control that enhances crops' tolerance to a broad range of pathogens.

In certain embodiments, the disclosure provides blends of one or more herbicides and one or more ascarosides, characterized in that the blended product reduces the phytotoxic effects on the crops to which it is applied compared to application of the one or more herbicides alone. In certain embodiments, the blend is characterized in that one or more phytotoxicity symptoms in a treated crop is reduced by at least 10% relative to use of a comparable composition lacking ascaroside(s). In certain embodiments, provided methods are characterized in that one or more phytotoxicity symptoms is reduced by at least 15%, by at least 20%, by at least 25%, by at least 35%, by at least 50%, by at least 75%, or by at least 90% relative to use of a comparable composition lacking ascaroside(s). In certain embodiments, provided blends are characterized in that one or more phytotoxicity symptoms are substantially absent relative to use of a comparable composition lacking ascaroside(s).

In some embodiments, the blend is characterized in that one or more phytotoxicity symptoms in a treated crop is reduced by 10-90%, 10-70%, 10-50%, 10-30%, 30-90%, 50-90%, 70-90%, 30-70%, or 30-50% relative to use of a comparable composition lacking ascaroside(s).

In some embodiments, phytotoxicity symptoms are measured by a phytotoxicity rating, e.g., as described by Example 2 herein. In some embodiments, the blend is characterized in that the phytotoxicity rating (e.g., as described in Example 2 herein) in a treated crop is reduced by at least 10% relative to use of a comparable composition lacking ascaroside(s). In certain embodiments, provided methods are characterized in that the phytotoxicity rating (e.g., as described in Example 2 herein) is reduced by at least 15%, by at least 20%, by at least 25%, by at least 35%, by at least 50%, by at least 75%, or by at least 90% relative to use of a comparable composition lacking ascaroside(s). In some embodiments, the blend is characterized in that the phytotoxicity rating (e.g., as described in Example 2 herein) in a treated crop is reduced by 10-90%, 10-70%, 10-50%, 10-30%, 30-90%, 50-90%, 70-90%, 30-70%, or 30-50% relative to use of a comparable composition lacking ascaroside(s).

In certain embodiments, phytotoxic effects that can be reduced by the use of ascarosides are selected from the group consisting of: poor germination; death of seedlings; death or damage to rapidly growing succulent tissues; stunting or delayed plant development; misshaped or distorted plants, fruits, or leaves; russeting or bronzing of leaves or fruit; dead spots or flecks on leaves; dead leaf tips or leaf margins; dead areas between the veins of the leaves; and combinations of any two or more of these.

The compounds described herein can be provided in a single formulation or agricultural composition or in separate formulations or agricultural compositions. Additionally, the components may be applied separately. When the one or more ascarosides and the one or more herbicides are applied separately, the one or more ascarosides can be applied before or after the application of the one or more herbicides. Generally, when applied separately, the components are co-applied at close points in time, e.g., substantially simultaneously or within about several minutes or hours, including within about 5 minutes, within about 10 minutes, within about 30 minutes, within about an hour, within about 2 hours, within about 3 hours, within about 4 hours, within about 6 hours, within about 7 hours, within about 8 hours, within about 24 hours, or within about 2 days of one another).

Co-application, can, in some embodiments, involve combining the one or more ascarosides and the one or more herbicides before application (e.g., immediately prior to application) to the plants. The one or more ascarosides and the one or more herbicides may be mixed in the field; for example, the one or more ascarosides can be added to a fully formulated tank mix comprising the one or more herbicides.

In other embodiments, the components to be co-applied can be combined at a timepoint further in advance of application. In such embodiments, an agricultural formulation is prepared comprising one or more ascarosides and the one or more herbicides in combination with one or more inert ingredients. Advantageously, in such combinations, the one or more ascarosides and the one or more herbicides are compatible with one another, and the resulting formulations can demonstrate stability over long periods of time (e.g., about one week or more, about one month or more, about two months or more, about three months or more, about four months or more, about five months or more, or about six months or more).

The one or more ascarosides and the one or more herbicides can be formulated together in a combination formulation. As noted above, the formulations or methods can include other active ingredients and/or plant or plant product treatment compounds. Further, some of the compositions will be residual in that they do not easily wash off the leaves during rain, and thus can protect plants during and after rainy weather.

In certain embodiments, the disclosure provides blends of one or more herbicides and one or more ascarosides where a weight ratio of herbicide(s) to ascaroside is greater than 100:1, greater than 500:1 or greater than 1000:1. In certain embodiments, the disclosure provides blends of a herbicide and an ascaroside where a weight ratio of a herbicide to ascaroside is greater than 1500:1, greater than 2000:1, greater than 3000:1, greater than 5000:1, greater than 7500:1, greater than 10,000:1, greater than 15,000:1, greater than 20,000:1, greater than 30,000:1, or greater than 50,000:1.

The formulations or compositions can be formulated as is conventional in the art and may be liquid or dry compositions. Dry compositions include powders and the like. The compositions can be utilized as liquid concentrates, Ready-To-Use (RTU) liquid sprays, dusts, or solids, depending upon the needs of the user. The formulation chosen will depend on the use of the product. In use, the composition can be applied directly to the plant.

In general, a formulation will include at least one ascaroside as described herein, or at least one ascaroside and one or more herbicides, and one or more agriculturally acceptable adjuvants (also referred to herein as “agriculturally suitable adjuvants”). Agriculturally suitable adjuvants are used to enhance the effectiveness of the compounds described herein and include, but are not limited to, surfactants, emulsifiers, oils, salts, and the like. The adjuvants may be added into the formulation or alternatively can be added separately at the time of application to the crops. In some embodiments, wetting agents, emulsifiers, spreaders, and the like may be used in the formulations. Formulations include concentrated versions, in which the present active agent (a compound as described herein) is present in a concentration of from 0.001 to 98.0 percent, with the remaining content being physiologically acceptable carriers. Such formulations, especially those with less than 50 percent of the present compound, can sometimes be used directly, but these formulations can also be diluted with other physiologically acceptable carriers to form more dilute treating formulations. These latter formulations can include the compounds described herein in lesser concentrations of from 0.001 to 0.1 percent.

The formulations may additionally contain “adjuvant surfactants” to enhance deposition, wetting, and penetration of the compounds onto the target crop and organism. These “adjuvant surfactants” may optionally be employed as a component of the formulation or as a tank mix. The amount of adjuvant surfactant will typically vary from 0.01 to 1.0 percent by volume, based on a spray-volume of water, preferably 0.05 to 0.5 volume percent. Suitable adjuvant surfactants include, but are not limited to ethoxylated nonyl phenols, ethoxylated synthetic or natural alcohols, salts of the esters or sulfosuccinic acids, ethoxylated organosilicones, ethoxylated fatty amines, blends of surfactants with mineral or vegetable oils, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C9-Cu alkylpolyglycoside; phosphated alcohol ethoxylate; natural primary alcohol (C12-Ci6) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG (400) dioleate-99. The formulations may also include oil-in-water emulsions.

“Surfactants” comprise typically about 0.5% to about 10% of the wettable powder. “Surfactants” include sulfonated lignins, condensed naphthalene-sulfonates, the naphthalene-sulfonates, alkyl-benenesulfonates, alkysulfonates or nonionic surfactants such as ethylene oxide adducts of alkylphenols or mixtures thereof.

Representative organic solvents which may be employed in preparing the emulsifiable concentrates of the disclosed ascaroside(s) and/or herbicide(s) are the aromatic liquids such as xylene, propyl benzene fractions; or mixed naphthalene fractions, mineral oils, substituted aromatic organic liquids such as dioctyl phthalate; kerosene; dialkyl amides of various fatty acids, particularly the dimethyl amides of fatty glycols and glycol derivatives such as the n-butyl ether, ethyl ether or methyl ether of diethylene glycol, the methyl ether of triethylene glycol, petroleum fractions or hydrocarbons such as mineral oil, aromatic solvents, paraffinic oils, and the like; terpenic solvents, rosin derivatives, aliphatic ketones such as cyclohexanone, complex aliphatic and aromatic alcohols such as 2-ethoxyethanol, vegetable oils such as soy bean oil, rape seed oil, olive oil, castor oil, sunflower seed oil, coconut oil, corn oil, cotton seed oil, linseed oil, palm oil, peanut oil, safflower oil, sesame oil, tung oil and the like; esters of the above vegetable oils; and the like. Mixtures of two or more organic liquids may also be employed in the preparation of the emulsifiable concentrate. Organic liquids include xylene, and propyl benzene fractions, with xylene being most preferred in some cases. Surface-active dispersing agents are typically employed in liquid formulations and in an amount of from 0.1 to 20 percent by weight based on the combined weight of the dispersing agent with one or more of the compounds.

“Emulsifiers” for emulsifiable concentrates are typically mixed ionic and/or nonionic surfactants such as those mentioned herein or their equivalents. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil soluble salts (e.g., calcium) of alkylaryl sulphonic acids, oil-soluble salts or sulfated polyglycol ethers and appropriate salts of phosphated-polyglycol ether.

Dusts containing the ascaroside(s) and/or herbicide(s) may be prepared by intimately mixing one or more of the compounds in powdered form with a suitable dusty agricultural carrier, such as, for example, kaolin clay, ground volcanic rock, and the like. Dusts can suitably contain from about 1 to about 10 weight percent of the compounds, based on the total weight of the dust.

Wettable powders may be agglomerated or compacted to form water dispersible granules. These granules include mixtures of compounds, inert carriers suitable for granular applications, and surfactants. The concentration of the compound is typically between about 0.1% to about 90% by weight. The “inert carrier suitable for granular applications” is typically prophyllite, talc, chalk, gypsum, Fuller's earth, bentonite, attapulgite, starch, casein, gluten, montmorillonite clays, diatomaceous earths, purified silicates, or the like. In such operations, the finely divided carrier and surfactants are typically blended with the compound(s) and milled.

“Aqueous suspensions” may be prepared where the one or more ascarosides and/or one or more herbicides are dispersed in an aqueous vehicle at a concentration typically in the range of between about 5% to about 50% by weight. The suspensions are prepared by finely grinding the compound and vigorously mixing it into a vehicle of water, surfactants, and dispersants. Inert ingredients such as inorganic salts and synthetic or natural gums may also be employed to increase the density and/or viscosity of the aqueous vehicle as is desired.

As described herein, the compositions and methods of the invention are useful for lessening the phytotoxic effects of the herbicide on the treated crop. The method comprises applying a combination of an effective amount of an ascaroside composition and an herbicide composition to a seed, a plant, plant foliage, or to the soil where the plant is grown.

### Definitions

In order for the present disclosure to be more readily understood, certain terms are defined below. Additional definitions for the following terms and other terms are set forth throughout the specification. In this application, unless otherwise clear from context, the term “a” may be understood to mean “at least one.”

As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Definitions of specific functional groups and chemical terms are described in more detail below. For purposes of this invention, the chemical elements are identified in accordance with the Periodic Table of the Elements, CAS version, Handbook of Chemistry and Physics, 75th Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5th Edition, John Wiley & Sons, Inc., New York, 2001; Larock, Comprehensive Organic Transformations, VCH Publishers, Inc., New York, 1989; Carruthers, Some Modern Methods of Organic Synthesis, 3rd Edition, Cambridge University Press, Cambridge, 1987; the entire contents of each of which are incorporated herein by reference.

Certain compounds provided herein can comprise one or more asymmetric centers, and thus can exist in various stereoisomeric forms, e.g., enantiomers and/or diastereomers. Thus, inventive compounds and compositions thereof may be in the form of an individual enantiomer, diastereomer or geometric isomer, or may be in the form of a mixture of stereoisomers. In certain embodiments, compounds described herein are enantiopure compounds. In certain other embodiments, mixtures of enantiomers or diastereomers are provided.

Furthermore, certain compounds as described herein may have one or more double bonds that can exist as either a Z or E isomer, unless otherwise indicated. The compounds can be provided as individual isomers substantially free of other isomers and alternatively, as mixtures of various isomers, e.g., racemic mixtures of enantiomers.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the disclosure. For instance, a compound may, in some embodiments, be provided substantially free of one or more corresponding stereoisomers, and may also be referred to as “stereochemically enriched.”

Where a particular enantiomer is preferred, it may, in some embodiments be provided substantially free of the opposite enantiomer, and may also be referred to as “optically enriched.” “Optically enriched,” as used herein, means that the compound is made up of a significantly greater proportion of one enantiomer. In certain embodiments the compound is made up of at least about 90% by weight of an enantiomer. In some embodiments the compound is made up of at least about 95%, 97%, 98%, 99%, 99.5%, 99.7%, 99.8%, or 99.9% by weight of an enantiomer. In some embodiments the enantiomeric excess of provided compounds is at least about 90%, 95%, 97%, 98%, 99%, 99.5%, 99.7%, 99.8%, or 99.9%. In some embodiments, enantiomers may be isolated from racemic mixtures by any method known to those skilled in the art, including chiral high pressure liquid chromatography (HPLC) and the formation and crystallization of chiral salts or prepared by asymmetric syntheses. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, NY, 1962); Wilen, S. H. Tables of Resolving Agents and Optical Resolutions p. 268 (E. L. Eliel, Ed., Univ. of Notre Dame Press, Notre Dame, IN 1972).

The terms “halo” and “halogen” as used herein refer to an atom selected from fluorine (fluoro, —F), chlorine (chloro, —Cl), bromine (bromo, —Br), and iodine (iodo, —I).

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-30 carbon atoms. In certain embodiments, aliphatic groups contain 1-12 carbon atoms. In certain embodiments, aliphatic groups contain 1-8 carbon atoms. In certain embodiments, aliphatic groups contain 1-6 carbon atoms. In some embodiments, aliphatic groups contain 1-5 carbon atoms, in some embodiments, aliphatic groups contain 1-4 carbon atoms, in yet other embodiments aliphatic groups contain 1-3 carbon atoms, and in yet other embodiments aliphatic groups contain 1-2 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic” or “heteroaliphatic group”, as used herein, denotes an aliphatic group where one or more carbon or hydrogen atoms are replaced by a heteroatom (e.g. oxygen, nitrogen, sulfur, phosphorous, boron, etc.). In some embodiments, a heteroaliphatic group is a heterocyclyl group.

The term “unsaturated”, as used herein, means that a moiety has one or more double or triple bonds.

The term “alkyl,” as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-12 carbon atoms. In certain embodiments, alkyl groups contain 1-8 carbon atoms. In certain embodiments, alkyl groups contain 1-6 carbon atoms. In some embodiments, alkyl groups contain 1-5 carbon atoms, in some embodiments, alkyl groups contain 1-4 carbon atoms, in yet other embodiments alkyl groups contain 1-3 carbon atoms, and in yet other embodiments alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “alkenyl,” as used herein, denotes a monovalent group derived from a straight- or branched-chain aliphatic moiety having at least one carbon-carbon double bond by the removal of a single hydrogen atom. Unless otherwise specified, alkenyl groups contain 2-12 carbon atoms. In certain embodiments, alkenyl groups contain 2-8 carbon atoms. In certain embodiments, alkenyl groups contain 2-6 carbon atoms. In some embodiments, alkenyl groups contain 2-5 carbon atoms, in some embodiments, alkenyl groups contain 2-4 carbon atoms, in yet other embodiments alkenyl groups contain 2-3 carbon atoms, and in yet other embodiments alkenyl groups contain 2 carbon atoms. Alkenyl groups include, for example, ethenyl, propenyl, butenyl, 1-methyl-2-buten-1-yl, and the like.

The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring”. In certain embodiments, “aryl” refers to an aromatic ring system which includes, but is not limited to, phenyl, biphenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, or tetrahydronaphthyl, and the like.

The terms “heteroaryl” and “heteroar-,” used alone or as part of a larger moiety, e.g., “heteroaralkyl,” or “heteroaralkoxy,” refer to groups having 5 to 10 ring atoms, preferably 5, 6, or 9 ring atoms; having 6, 10, or 14 pelectrons shared in a cyclic array; and having, in addition to carbon atoms, from one to five heteroatoms. The term “heteroatom” refers to nitrogen, oxygen, or sulfur, and includes any oxidized form of nitrogen or sulfur, and any quaternized form of a basic nitrogen. Heteroaryl groups include, without limitation, thienyl, furanyl, pyrrolyl, imidazolyl, pyrazolyl, triazolyl, tetrazolyl, oxazolyl, isoxazolyl, oxadiazolyl, thiazolyl, isothiazolyl, thiadiazolyl, pyridyl, pyridazinyl, pyrimidinyl, pyrazinyl, indolizinyl, purinyl, naphthyridinyl, and pteridinyl. The terms “heteroaryl” and “heteroar-”, as used herein, also include groups in which a heteroaromatic ring is fused to one or more aryl, cycloaliphatic, or heterocyclyl rings, where the radical or point of attachment is on the heteroaromatic ring. Nonlimiting examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. A heteroaryl group may be monocyclic, bicyclic, bridged bicyclic, or spirocyclic. The term “heteroaryl” may be used interchangeably with the terms “heteroaryl ring,” “heteroaryl group,” or “heteroaromatic,” any of which terms include rings that are optionally substituted. The term “heteroaralkyl” refers to an alkyl group substituted by a heteroaryl, wherein the alkyl and heteroaryl portions independently are optionally substituted. The term “heteroarylenyl” refers to bivalent heteroaryl groups (e.g., pyridylenyl).

As used herein, the terms “heterocycle,” “heterocyclyl,” “heterocyclic radical,” and “heterocyclic ring” are used interchangeably and refer to a stable 5- to 7-membered monocyclic or 7-10-membered bicyclic heterocyclic moiety that is either saturated or partially unsaturated, and having, in addition to carbon atoms, one or more, preferably one to four, heteroatoms, as defined above. When used in reference to a ring atom of a heterocycle, the term “nitrogen” includes a substituted nitrogen. As an example, in a saturated or partially unsaturated ring having 0-3 heteroatoms selected from oxygen, sulfur or nitrogen, the nitrogen may be N (as in 3,4-dihydro-2H-pyrrolyl), NH (as in pyrrolidinyl), or +NR (as in N-substituted pyrrolidinyl).

A heterocyclic ring can be attached to its pendant group at any heteroatom or carbon atom that results in a stable structure and any of the ring atoms can be optionally substituted. Examples of such saturated or partially unsaturated heterocyclic radicals include, without limitation, tetrahydrofuranyl, tetrahydrothiophenyl pyrrolidinyl, piperidinyl, pyrrolinyl, tetrahydroquinolinyl, tetrahydroisoquinolinyl, decahydroquinolinyl, oxazolidinyl, piperazinyl, dioxanyl, dioxolanyl, diazepinyl, oxazepinyl, thiazepinyl, morpholinyl, and quinuclidinyl. The terms “heterocycle,” “heterocyclyl,” “heterocyclyl ring,” “heterocyclic group,” “heterocyclic moiety,” and “heterocyclic radical,” are used interchangeably herein, and also include groups in which a heterocyclyl ring is fused to one or more aryl, heteroaryl, or cycloaliphatic rings, such as indolinyl, 3H-indolyl, chromanyl, phenanthridinyl, or tetrahydroquinolinyl. In some embodiments, a heterocyclic ring may be a 5-12 membered bicyclic, bridged bicyclic, or spirocyclic ring. A heterocyclic ring may include one or more oxo (═O) or thioxo (═S) substituent. The term “heterocyclylalkyl” refers to an alkyl group substituted by a heterocyclyl, wherein the alkyl and heterocyclyl portions independently are optionally substituted.

As used herein, the term “partially unsaturated” refers to a ring moiety that includes at least one double or triple bond. The term “partially unsaturated” is intended to encompass rings having multiple sites of unsaturation, but is not intended to include aryl or heteroaryl moieties, as herein defined.

As described herein, compounds as provided herein may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned are preferably those that result in the formation of stable or chemically feasible compounds. The term “stable,” as used herein, refers to compounds that are not substantially altered when subjected to conditions to allow for their production, detection, and, in certain embodiments, their recovery, purification, and use for one or more of the purposes disclosed herein.

Suitable monovalent substituents on a substitutable carbon atom of an “optionally substituted” group are independently halogen; —(CH₂)₀₋₄R^{∘}; —(CH₂)₀₋₄OR^{∘}; —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; (CH₂)₀₋₄N(R^{∘})C(O)NR^{∘})₂; —N(R^{∘})C(S)NR^{∘})₂; —(CH₂)₀₋₄N(R^{∘})C(O)OR^{∘}; —N(R^{∘})N(R^{∘})C(O)R^{∘}; —N(R^{∘})N(R^{∘})C(O)NR^{∘})₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)N(R^{∘})₂; —(CH₂)₀₋₄C(O)SR^{∘}; —(CH₂)₀₋₄C(O)OSiR^{∘}₃; —(CH₂)₀₋₄₀C(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘})₂; —C(S)NR^{∘})₂; —C(S)SR^{∘}; —SC(S)SR^{∘}, —(CH₂)₀₋₄₀C(O)NR^{∘})₂; —C(O)N(OR^{∘}) R^{∘}; —C(O) C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘})₂; —(CH₂)₀₋₄S(O)R^{∘}; —N(R^{∘})S(O)₂NR^{∘})₂; N(R^{∘})S(O)₂R^{∘}; —N(OR^{∘}) R^{∘}; —C(NH)NR^{∘})₂; —P(O)₂R^{∘}; —P(O)R^{∘})₂; —OP(O)R^{∘})₂; —OP(O)(OR^{∘})₂; SiR^{∘}₃; —(C₁₋₄ straight or branched alkylene)O—N(R^{∘})₂; or —(C₁₋₄ straight or branched alkylene)C(O)O—N(R^{∘})₂, wherein each R^{∘} may be substituted as defined below and is independently hydrogen, C₁₋₈ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or polycyclic ring having 0-4 heteroatoms independently selected from nitrogen, oxygen, or sulfur, which may be substituted as defined below.

Suitable monovalent substituents of R^{∘} together with their intervening atoms), are independently halogen, —(CH₂)₀₋₂R^{●}, -(haloR^{∘}), —(CH₂)₀₋₂OH, —(CH₂)₀₋₂OR^{●}, (CH₂)₀₋₂CH(OR)₂; —O(haloR^{∘}, —CN, —N₃, —(CH₂)₀₋₂C(O)R^{●}, —(CH₂)₀₋₂C(O)OH, —(CH₂)₀₋₂C(O)OR^{●}, —(CH₂)₀₋₄C(O)N(R^{●})₂; —(CH₂)₀₋₂SR^{●}, —(CH₂)₀₋₂SH, —(CH₂)₀₋₂NH₂, —(CH₂)₀₋₂NHR^{●}, —(CH₂)₀₋₂NR^{●})₂, —NO₂, —SiR^{●}₃, —OSiR^{●}₃, —C(O)SR^{●}, —(C₁₋₄ straight or branched alkylene) C(O)OR^{●}, or —SSR^{●} wherein each R^{●} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{∘} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, —NR*, ═NOR*, —O(C(R*₂))₂₋₃O—, or —S(C(R*₂))₂₋₃S—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{∘}, -(haloR^{∘}, —OH, —OR^{∘}, —O(haloR^{∘}, —CN, —C(O)OH, —C(O)OR^{∘}, —NH₂, —NHR^{∘}, —NR^{∘})₂, or —NO₂, wherein each R is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O) C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of Rt are independently halogen, —R^{●}, -(haloR^{●}, —OH, —OR^{●}, —O(haloR^{●}), —CN, —C(O)OH, —C(O)OR^{●}, —NH₂, —NHR^{●}, —NR^{●})₂, or —NO₂, wherein each R^{●} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

As used herein, the term “substantially” refers to the qualitative condition of exhibiting total or near-total extent or degree of a characteristic or property of interest.

The convention of naming ascarosides by a several-letter prefix followed by a pound sign (#) and a number is sometimes used (for example ascr #18). This convention is used in the scientific literature and the skilled artisan will understand that each such name is associated with a specific chemical structure of known composition and will readily apprehend the structure of the molecule referred to using this naming convention. Unless otherwise indicated, all compound identifiers of this format used herein conform to the definitions described in the C. elegans Small Molecule Identifier Database (SMID-DB) maintained on the World Wide Web at smid-db.org.

Embodiments of the invention include:
1. A method for reducing phytotoxic side effects on plants during application of an herbicide, said method comprising contacting a plant or a plant part with an effective amount of a combination of agents, said agents comprising at least one ascaroside and at least one herbicide, wherein said effective amount of ascaroside reduces phytotoxic side effects on crop plants during application of an herbicide.
2. The method of embodiment 1, wherein the herbicide is a PPO Herbicide, an Auxin Herbicide, an ALS/AHAS Herbicide, an ACCase Inhibitor Herbicide, a Carotenoid Biosynthesis Inhibitor Herbicide, a Cellulose Inhibitor Herbicide, an EPSP Inhibitor Herbicide, a Glutamine Synthesis Inhibitor Herbicide, a Lipid Synthesis Inhibitor Herbicide, a Microtubule Assembly Inhibitor Herbicide or a Photosystem Inhibitor Herbicide.
3. The method of embodiment 1, wherein the herbicide is selected from the groups of: carbamates; thiocarbamates; haloacetanilides; substituted phenoxy-, naphthoxy- and phenoxyphenoxy carboxylic acid derivatives; heteroaryloxyphenoxyalkane carboxylic acid derivatives; quinolyloxy-, quinoxalyloxy-, pyridyloxy-, benzoxazolyloxy- and benzothiazolyloxyphenoxyalkane carboxylic acid esters; cyclohexanedione derivatives; imidazolinones; pyrimidinyloxypyridincarboxylic acid derivatives; pyrimidyloxybenzoic acid derivatives; sulfonylureas; triazolopyrimidinesulfonamide derivatives; S—(N-aryl-N-alkylcarbamoylmethyl)dithiophosphoric esters; hormone-type herbicides; pyridinecarboxylic acids; triazinones; triazolinones; pyridinecarboxamides; hydroxybenzonitriles; isoxazoles; phenoxyphenoxy- and heteroaryloxyphenoxy carboxylic acid esters and salts, sulfonylureas, imidazolinones; and isoxazoles.
4. The method of embodiment 1, wherein said at least one herbicide is a PPO Herbicide.
5. The method of embodiment 4, wherein said PPO Herbicide is aclonifen, acifluorfen, bifenox, butafenacil, flumioxazin, fomesafen, oxyfluorfen, oxadiazon, saflufenacil, or sulfentrazone.
6. The method of embodiment 1, wherein said at least one herbicide is an Auxin herbicide.
7. The method of embodiment 6, wherein said Auxin Herbicide is aminopyralid, aminocyclopyrachlor, 4-(4-chloro-o-tolyloxy)butyric acid (MCPB), clopyralid, dicamba, diflufenzopyr, 2,4-dichlorophenoxyacetic acid (2,4-D), 4-(2,4-dichlorophenoxy)butyric acid (2,4-DB), fluroxypyr, mecoprop, 2-methyl-4-chlorophenoxyacetic acid (MCPA), picloram, quinclorac, 2,4,5-trichlorophenoxyacetic acid (2,4,5-T), or triclopyr.
8. The method of embodiment 1, wherein said at least one herbicide is an ALS/AHAS Herbicide.
9. The method of embodiment 8, wherein said ALS/AHAS Herbicide is bensulfuron, chlorimuron, cloransulam, chlorsulfuron, diclosulam, florasulam, flucarbazone, flumetsulam, foramsulfuron, halosulfuron, imazamethabenz, imazamox, imazapic, imazapyr, imazaquin, imazethapyr, mesosulfuron, metsulfuron, nicosulfuron, penoxsulam, primisulfuron, propoxycarbazone, prosulfuron, pyrithiobac, pyroxsulam, rimsulfuron, sulfometuron, sulfosulfuron, thifensulfuron, triasulfuron, tribenuron, trifloxysulfuron, or triflusulfuron.
10. The method of embodiment 1, wherein said at least one herbicide is an ACCase Inhibitor Herbicide.
11. The method of embodiment 10, wherein said ACCase Inhibitor Herbicide is butroxydim, clethodim, cyhalofop, diclofop, fenoxaprop, fluazifop, haloxyfop, pinoxaden, quizalofop, sethoxydim, or tralkoxydim.
12. The method of embodiment 1, wherein said at least one herbicide is a Carotenoid Biosynthesis Inhibitor Herbicide.
13. The method of embodiment 12, wherein said Carotenoid Biosynthesis Inhibitor Herbicides is amitrole, clomazone, fluridone, isoxaflutole, mesotrione, norflurazon, pyrasulfotole, tembotrione, or topramezone.
14. The method of embodiment 1, wherein said at least one herbicide is a Cellulose Inhibitor Herbicide.
15. The method of embodiment 14, wherein said Cellulose Inhibitor Herbicide is dichlobenil, flupoxam, indaziflam, isoxaben, and quinclorac.
16. The method of embodiment 1, wherein said at least one herbicide is glyphosate.
17. The method of embodiment 1, wherein said at least one herbicide is glufosinate.
18. The method of embodiment 1, wherein said at least one herbicide is a Lipid Synthesis Inhibitor Herbicide.
19. The method of embodiment 18, wherein said Lipid Synthesis Inhibitor Herbicide is acetochlor, alachlor, bensulide, benthiocarb, chloroacetamide, cycloate, dimethenamid, S-ethyl-N,N-dipropylthiocarbamate (EPTC), ethofumesate, flufenacet, metolachlor, napropamide, propachlor, or triallate.
20. The method of embodiment 1, wherein said at least one herbicide is a Microtubule Assembly Inhibitor Herbicide.
21. The method of embodiment 20, wherein said Microtubule Assembly Inhibitor Herbicide is benefin, benfluralin, dimethyl tetrachloroterephthalate (DCPA), dithiopyr, ethalfluralin, oryzalin, pendimethalin, prodiamine, propyzamide (pronamide), thiazopyr, or trifluralin.
22. The method of embodiment 1, wherein said at least one herbicide is a Photosystem Inhibitor Herbicide.
23. The method of embodiment 22, wherein said Photosystem Inhibitor Herbicide is atrazine, diquat, diuron, linuron, metribuzin, paraquat, or simazine.
24. The method of any one of embodiments 1-23, wherein said at least one ascaroside comprises an ascaroside having the structure (I):

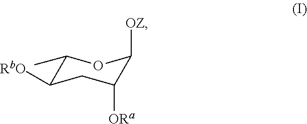

where:
Z is an optionally substituted C₃₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{∘}), a C₂₋₂₀ carbamate (e.g. -a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule. Where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.
25. The method of embodiment 24, wherein Z is selected from the group consisting of:
   i. —CH(CH₃)—R¹, where R¹ is an optionally substituted C₁₋₄₀ aliphatic group ii. —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   iii. —CH(CH₃)—(CH₂)ₙ—CH—CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   iv. —CH(CH₃)—(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   v. —CH(CH₃)—(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   vi. —(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   vii. —(CH₂)ₙ—CH—CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   viii. —(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide; and
   ix. —(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
26. The method of embodiment 24, wherein Z is selected from the group consisting of:
   (x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xi) —CH(CH₃)—(CH₂)ₙ—CH—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xii) —CH(CH₃)—(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiii) —CH(CH₃)—(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xvi) —(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
   (xvii) —(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.
27. The method of any one of embodiments 24-26, wherein R^{a} and R^{b} are each —H.
28. The method of any one of embodiments 24-27, wherein Z is —CH(CH₃) (CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
29. The method of any one of embodiments 1-28, wherein said at least one ascaroside comprises an ascaroside selected from the group consisting of ascr #9, ascr #10, ascr #16, ascr #18, ascr #20, ascr #22, and ascr #24.
30. The method of any one of embodiments 1-29, wherein said at least one ascaroside comprises ascr #18.
31. The method of any one of embodiments 1-30, wherein said at least one ascaroside and said at least one herbicide are applied simultaneously.
32. The method of embodiment 31, wherein said at least one ascaroside and said at least one herbicide are combined together in a tank mix.
33. The method of any one of embodiments 1-30, wherein said at least one ascaroside and said at least one herbicide are applied sequentially.
34. The method of any one of embodiments 1-33, wherein said combination is used as a seed coating.
35. A composition comprising at least one ascaroside and at least one herbicide.
36. The composition of embodiment 35, wherein said at least one ascaroside and said at least one herbicide are present in effective amounts.
37. The composition of embodiment 35, wherein the herbicide is a PPO Herbicide, an Auxin Herbicide, an ALS/AHAS Herbicide, an ACCase Inhibitor Herbicide, a Carotenoid Biosynthesis Inhibitor Herbicide, a Cellulose Inhibitor Herbicide, an EPSP Inhibitor Herbicide, a Glutamine Synthesis Inhibitor Herbicide, a Lipid Synthesis Inhibitor Herbicide, a Microtubule Assembly Inhibitor Herbicide or a Photosystem Inhibitor Herbicide.
38. The composition of embodiment 35, wherein the herbicide is selected from the groups of: carbamates; thiocarbamates; haloacetanilides; substituted phenoxy-, naphthoxy- and phenoxyphenoxy carboxylic acid derivatives; heteroaryloxyphenoxyalkane carboxylic acid derivatives; quinolyloxy-, quinoxalyloxy-, pyridyloxy-, benzoxazolyloxy- and benzothiazolyloxyphenoxyalkane carboxylic acid esters; cyclohexanedione derivatives; imidazolinones; pyrimidinyloxypyridincarboxylic acid derivatives; pyrimidyloxybenzoic acid derivatives; sulfonylureas; triazolopyrimidinesulfonamide derivatives; S—(N-aryl-N-alkylcarbamoylmethyl)dithiophosphoric esters; hormone-type herbicides; pyridinecarboxylic acids; triazinones; triazolinones; pyridinecarboxamides; hydroxybenzonitriles; isoxazoles; phenoxyphenoxy- and heteroaryloxyphenoxy carboxylic acid esters and salts, sulfonylureas, imidazolinones; and isoxazoles.
39. The composition of embodiment 35, wherein said at least one herbicide is a PPO Herbicide.
40. The composition of embodiment 39, wherein said PPO Herbicide is aclonifen, acifluorfen, bifenox, butafenacil, flumioxazin, fomesafen, oxyfluorfen, oxadiazon, saflufenacil, or sulfentrazone.
41. The composition of embodiment 35, wherein said at least one herbicide is an Auxin herbicide.
42. The composition of embodiment 41, wherein said Auxin Herbicide is aminopyralid, aminocyclopyrachlor, 4-(4-chloro-o-tolyloxy)butyric acid (MCPB), clopyralid, dicamba, diflufenzopyr, 2,4-dichlorophenoxyacetic acid (2,4-D), 4-(2,4-dichlorophenoxy)butyric acid (2,4-DB), fluroxypyr, mecoprop, 2-methyl-4-chlorophenoxyacetic acid (MCPA), picloram, quinclorac, 2,4,5-trichlorophenoxyacetic acid (2,4,5-T), or triclopyr.
43. The composition of embodiment 35, wherein said at least one herbicide is an ALS/AHAS Herbicide.
44. The composition of embodiment 43, wherein said ALS/AHAS Herbicide is bensulfuron, chlorimuron, cloransulam, chlorsulfuron, diclosulam, florasulam, flucarbazone, flumetsulam, foramsulfuron, halosulfuron, imazamethabenz, imazamox, imazapic, imazapyr, imazaquin, imazethapyr, mesosulfuron, metsulfuron, nicosulfuron, penoxsulam, primisulfuron, propoxycarbazone, prosulfuron, pyrithiobac, pyroxsulam, rimsulfuron, sulfometuron, sulfosulfuron, thifensulfuron, triasulfuron, tribenuron, trifloxysulfuron, or triflusulfuron.
45. The composition of embodiment 35, wherein said at least one herbicide is an ACCase Inhibitor Herbicide.
46. The composition of embodiment 45, wherein said ACCase Inhibitor Herbicide is butroxydim, clethodim, cyhalofop, diclofop, fenoxaprop, fluazifop, haloxyfop, pinoxaden, quizalofop, sethoxydim, or tralkoxydim.
47. The composition of embodiment 35, wherein said at least one herbicide is a Carotenoid Biosynthesis Inhibitor Herbicide.
48. The composition of embodiment 47, wherein said Carotenoid Biosynthesis Inhibitor Herbicides is amitrole, clomazone, fluridone, isoxaflutole, mesotrione, norflurazon, pyrasulfotole, tembotrione, or topramezone.
49. The composition of embodiment 35, wherein said at least one herbicide is a Cellulose Inhibitor Herbicide.
50. The composition of embodiment 49, wherein said Cellulose Inhibitor Herbicide is dichlobenil, flupoxam, indaziflam, isoxaben, and quinclorac.
51. The composition of embodiment 35, wherein said at least one herbicide is glyphosate.
52. The composition of embodiment 35, wherein said at least one herbicide is glufosinate.
53. The composition of embodiment 35, wherein said at least one herbicide is a Lipid Synthesis Inhibitor Herbicide.
54. The composition of embodiment 53, wherein said Lipid Synthesis Inhibitor Herbicide is acetochlor, alachlor, bensulide, benthiocarb, chloroacetamide, cycloate, dimethenamid, S-ethyl-N,N-dipropylthiocarbamate (EPTC), ethofumesate, flufenacet, metolachlor, napropamide, propachlor, or triallate.
55. The composition of embodiment 35, wherein said at least one herbicide is a Microtubule Assembly Inhibitor Herbicide.
56. The composition of embodiment 55, wherein said Microtubule Assembly Inhibitor Herbicide is benefin, benfluralin, dimethyl tetrachloroterephthalate (DCPA), dithiopyr, ethalfluralin, oryzalin, pendimethalin, prodiamine, propyzamide (pronamide), thiazopyr, or trifluralin.
57. The composition of embodiment 35, wherein said at least one herbicide is a Photosystem Inhibitor Herbicide.
58. The composition of embodiment 57, wherein said Photosystem Inhibitor Herbicide is atrazine, diquat, diuron, linuron, metribuzin, paraquat, or simazine.
59. The composition of any one of embodiments 35-58 wherein said at least one ascaroside comprises an ascaroside having the structure (I):

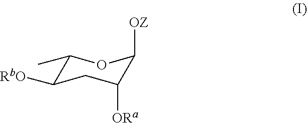

where:
Z is an optionally substituted C₃₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{c}), a C₂₋₂₀ carbamate (e.g. -a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule. Where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.
60. The composition of embodiment 59, wherein Z is selected from the group consisting of:
   i. —CH(CH₃)—R¹, where R¹ is an optionally substituted C₁₋₄₀ aliphatic group
   ii. —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   iii. —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   iv. —CH(CH₃)—(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   v. —CH(CH₃)—(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   vi. —(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   vii. —(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   viii. —(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide; and
   ix. —(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
61. The composition of embodiment 47, wherein Z is:
   (x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xi) —CH(CH₃)—(CH₂)ₙ—CH—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xii) —CH(CH₃)—(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiii) —CH(CH₃)—(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xv) —(CH₂)ₙ—CH—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xvi) —(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
   (xvii) —(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.
62. The composition of embodiment 60 or 61, wherein R^{a} and R^{b} are each —H.
63. The composition of any one of embodiments 59-62, wherein Z is —CH(CH₃) (CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
64. The composition of any one of embodiments 35-63, wherein said at least one ascaroside comprises an ascaroside selected from the group consisting of ascr #9, ascr #10, ascr #16, ascr #18, ascr #20, ascr #22, and ascr #24.
65. The composition of any one of embodiments 35-63, wherein said at least one ascaroside comprises ascr #18.
66. The composition of any one of embodiments 35-65, wherein said composition is part of a tank mix.
67. The composition of any one of embodiments 35-65, wherein said composition is in a solid form.
68. The composition of embodiment 67, wherein said solid form comprises powder or granules.
69. The composition of any one of embodiments 35-65, wherein said composition is in liquid form.
70. The composition of embodiment 69, wherein said liquid form is a sprayable formulation.
71. The composition of any one of embodiments 35-70, wherein the composition is stable for a period of greater than 6 months.
72. The composition of any one of embodiments 35-71, wherein said composition further comprises one or more additional components selected from the group consisting of surfactants, including emulsifiers, dispersants, foam-formers, colorants, processing aids, lubricants, fillers, reinforcements, flame retardants, light stabilizers, ultraviolet radiation absorbers, weather stabilizers, plasticizers, release agents, perfumes, heat-retaining additives (e.g., silica), cross-linking agents, antioxidants, anti-foaming agents, buffers, pH modifiers, compatibility agents, drift control additives, extenders/stickers, tackifiers, plant penetrants, safeners, spreaders, and wetting agents.

Embodiments of the invention include:
1. A method for reducing phytotoxic side effects on plants associated with application of an herbicide, said method comprising contacting a plant or a plant part with an effective amount of a combination of agents, said agents comprising at least one ascaroside and at least one herbicide, wherein said effective amount reduces phytotoxic side effects on crop plants as compared to phytotoxic side effects on plants associated with application of the herbicide alone.
2. The method of embodiment 1, wherein the herbicide is a PPO Herbicide, an Auxin Herbicide, an ALS/AHAS Herbicide, an ACCase Inhibitor Herbicide, a Carotenoid Biosynthesis Inhibitor Herbicide, a Cellulose Inhibitor Herbicide, an EPSP Inhibitor Herbicide, a Glutamine Synthesis Inhibitor Herbicide, a Lipid Synthesis Inhibitor Herbicide, a Microtubule Assembly Inhibitor Herbicide or a Photosystem Inhibitor Herbicide.
3. The method of embodiment 1, wherein the herbicide is selected from the groups of: carbamates; thiocarbamates; haloacetanilides; substituted phenoxy-, naphthoxy- and phenoxyphenoxy carboxylic acid derivatives; heteroaryloxyphenoxyalkane carboxylic acid derivatives; quinolyloxy-, quinoxalyloxy-, pyridyloxy-, benzoxazolyloxy- and benzothiazolyloxyphenoxyalkane carboxylic acid esters; cyclohexanedione derivatives; imidazolinones; pyrimidinyloxypyridincarboxylic acid derivatives; pyrimidyloxybenzoic acid derivatives; sulfonylureas; triazolopyrimidinesulfonamide derivatives; S—(N-aryl-N-alkylcarbamoylmethyl)dithiophosphoric esters; hormone-type herbicides; pyridinecarboxylic acids; triazinones; triazolinones; pyridinecarboxamides; hydroxybenzonitriles; isoxazoles; phenoxyphenoxy- and heteroaryloxyphenoxy carboxylic acid esters and salts, sulfonylureas, imidazolinones; and isoxazoles.
4. The method of embodiment 1, wherein said at least one herbicide is a PPO Herbicide.
5. The method of embodiment 4, wherein said PPO Herbicide is aclonifen, acifluorfen, bifenox, butafenacil, flumioxazin, fomesafen, oxyfluorfen, oxadiazon, saflufenacil, or sulfentrazone.
6. The method of embodiment 1, wherein said at least one herbicide is an Auxin herbicide.
7. The method of embodiment 6, wherein said Auxin Herbicide is aminopyralid, aminocyclopyrachlor, 4-(4-chloro-o-tolyloxy)butyric acid (MCPB), clopyralid, dicamba, diflufenzopyr, 2,4-dichlorophenoxyacetic acid (2,4-D), 4-(2,4-dichlorophenoxy)butyric acid (2,4-DB), fluroxypyr, mecoprop, 2-methyl-4-chlorophenoxyacetic acid (MCPA), picloram, quinclorac, 2,4,5-trichlorophenoxyacetic acid (2,4,5-T), or triclopyr.
8. The method of embodiment 1, wherein said at least one herbicide is an ALS/AHAS Herbicide.
9. The method of embodiment 8, wherein said ALS/AHAS Herbicide is bensulfuron, chlorimuron, cloransulam, chlorsulfuron, diclosulam, florasulam, flucarbazone, flumetsulam, foramsulfuron, halosulfuron, imazamethabenz, imazamox, imazapic, imazapyr, imazaquin, imazethapyr, mesosulfuron, metsulfuron, nicosulfuron, penoxsulam, primisulfuron, propoxycarbazone, prosulfuron, pyrithiobac, pyroxsulam, rimsulfuron, sulfometuron, sulfosulfuron, thifensulfuron, triasulfuron, tribenuron, trifloxysulfuron, or triflusulfuron.
10. The method of embodiment 1, wherein said at least one herbicide is an ACCase Inhibitor Herbicide.
11. The method of embodiment 10, wherein said ACCase Inhibitor Herbicide is butroxydim, clethodim, cyhalofop, diclofop, fenoxaprop, fluazifop, haloxyfop, pinoxaden, quizalofop, sethoxydim, or tralkoxydim.
12. The method of embodiment 1, wherein said at least one herbicide is a Carotenoid Biosynthesis Inhibitor Herbicide.
13. The method of embodiment 12, wherein said Carotenoid Biosynthesis Inhibitor Herbicides is amitrole, clomazone, fluridone, isoxaflutole, mesotrione, norflurazon, pyrasulfotole, tembotrione, or topramezone.
14. The method of embodiment 1, wherein said at least one herbicide is a Cellulose Inhibitor Herbicide.
15. The method of embodiment 14, wherein said Cellulose Inhibitor Herbicide is dichlobenil, flupoxam, indaziflam, isoxaben, and quinclorac.
16. The method of embodiment 1, wherein said at least one herbicide is glyphosate.
17. The method of embodiment 1, wherein said at least one herbicide is glufosinate.
18. The method of embodiment 1, wherein said at least one herbicide is a Lipid Synthesis Inhibitor Herbicide.
19. The method of embodiment 18, wherein said Lipid Synthesis Inhibitor Herbicide is acetochlor, alachlor, bensulide, benthiocarb, chloroacetamide, cycloate, dimethenamid, S-ethyl-N,N-dipropylthiocarbamate (EPTC), ethofumesate, 1 flufenacet, metolachlor, napropamide, propachlor, or triallate.
20. The method of embodiment 1, wherein said at least one herbicide is a Microtubule Assembly Inhibitor Herbicide.
21. The method of embodiment 20, wherein said Microtubule Assembly Inhibitor Herbicide is benefin, benfluralin, dimethyl tetrachloroterephthalate (DCPA), dithiopyr, ethalfluralin,
22. The method of embodiment 1, wherein said at least one herbicide is a Photosystem Inhibitor Herbicide.
23. The method of embodiment 22, wherein said Photosystem Inhibitor Herbicide is atrazine, diquat, diuron, linuron, metribuzin, paraquat, or simazine.
24. The method of any one of embodiments 1-23, wherein said at least one ascaroside comprises an ascaroside having the structure (I):

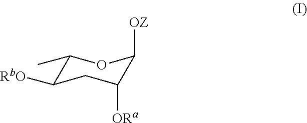

where:
Z is an optionally substituted C₃₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{∘}), a C₂₋₂₀ carbamate (e.g. -a moiety —C(O)N(Re) 2), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule. Where R^{∘} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.
25. The method of embodiment 24, wherein Z is selected from the group consisting of:
   i. —CH(CH₃)—R¹, where R¹ is an optionally substituted C₁₋₄₀ aliphatic group
   ii. —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   iii. —CH(CH₃)—(CH₂), —CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   iv. —CH(CH₃)—(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   v. —CH(CH₃)—(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   vi. —(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   vii. —(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   viii. —(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide; and
   ix. —(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
26. The method of embodiment 24, wherein Z is selected from the group consisting of:
   (x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xi) —CH(CH₃)—(CH₂)ₙ—CH—CH—CON(R³)₂, where n is an integer from 1 to 40, and each R³ is independently —H, an optionally substituted C₁₋₂₀ aliphatic group, an optionally optionally substituted heteroaryl group, a polymer chain, an amino acid, a peptide, a nucleotide, or a linkage via a bond or a carbon-containing linker moiety to another ascaroside molecule;
   (xii) —CH(CH₃)—(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiii) —CH(CH₃)—(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xv) —(CH₂)ₙ—CH—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xvi) —(CH₂)ₙ—CH(OH)—CH₂—CON(R³)₂, where n is an integer from 1 to 40, and each R³ is independently —H, an optionally substituted C₁₋₂₀ aliphatic group, an optionally optionally substituted heteroaryl group, a polymer chain, an amino acid, a peptide, a nucleotide, or a linkage via a bond or a carbon-containing linker moiety to another ascaroside molecule;
   (xvii) —(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
   (xviii) an optionally unsaturated, optionally substituted C₂₋₄₀ sidechain terminating in a chain end comprising a nitrogen-, oxygen- or sulfur-containing functional group.
27. The method of any one of embodiments 24-26, wherein R^{a} and R^{b} are each —H.
28. The method of any one of embodiments 24-27, wherein Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
29. The method of any one of embodiments 1-28, wherein said at least one ascaroside comprises an ascaroside selected from the group consisting of ascr #9, ascr #10, ascr #16, ascr #18, ascr #20, ascr #22, and ascr #24.
30. The method of any one of embodiments 1-29, wherein said at least one ascaroside comprises ascr #18.
31. The method of any one of embodiments 1-30, wherein said at least one ascaroside and said at least one herbicide are applied simultaneously.
32. The method of embodiment 31, wherein said at least one ascaroside and said at least one herbicide are combined together in a tank mix.
33. The method of any one of embodiments 1-30, wherein said at least one ascaroside and said at least one herbicide are applied sequentially.
34. The method of any one of embodiments 1-33, wherein said combination is used as a seed coating.
35. A composition comprising at least one ascaroside and at least one herbicide.
36. The composition of embodiment 35, wherein said at least one ascaroside and said at least one herbicide are present in effective amounts.
37. The composition of embodiment 35, wherein the herbicide is a PPO Herbicide, an Auxin Herbicide, an ALS/AHAS Herbicide, an ACCase Inhibitor Herbicide, a Carotenoid Biosynthesis Inhibitor Herbicide, a Cellulose Inhibitor Herbicide, an EPSP Inhibitor Herbicide, a Glutamine Synthesis Inhibitor Herbicide, a Lipid Synthesis Inhibitor Herbicide, a Microtubule Assembly Inhibitor Herbicide or a Photosystem Inhibitor Herbicide.
38. The composition of embodiment 35, wherein the herbicide is selected from the groups of: carbamates; thiocarbamates; haloacetanilides; substituted phenoxy-, naphthoxy- and phenoxyphenoxy carboxylic acid derivatives; heteroaryloxyphenoxyalkane carboxylic acid derivatives; quinolyloxy-, quinoxalyloxy-, pyridyloxy-, benzoxazolyloxy- and benzothiazolyloxyphenoxyalkane carboxylic acid esters; cyclohexanedione derivatives; imidazolinones; pyrimidinyloxypyridincarboxylic acid derivatives; pyrimidyloxybenzoic acid derivatives; sulfonylureas; triazolopyrimidinesulfonamide derivatives; S—(N-aryl-N-alkylcarbamoylmethyl)dithiophosphoric esters; hormone-type herbicides; pyridinecarboxylic acids; triazinones; triazolinones; pyridinecarboxamides; hydroxybenzonitriles; isoxazoles; phenoxyphenoxy- and heteroaryloxyphenoxy carboxylic acid esters and salts, sulfonylureas, imidazolinones; and isoxazoles.
39. The composition of embodiment 35, wherein said at least one herbicide is a PPO Herbicide.
40. The composition of embodiment 39, wherein said PPO Herbicide is aclonifen, acifluorfen, bifenox, butafenacil, flumioxazin, fomesafen, oxyfluorfen, oxadiazon, saflufenacil, or sulfentrazone.
41. The composition of embodiment 35, wherein said at least one herbicide is an Auxin herbicide.
42. The composition of embodiment 41, wherein said Auxin Herbicide is aminopyralid, aminocyclopyrachlor, 4-(4-chloro-o-tolyloxy)butyric acid (MCPB), clopyralid, dicamba, diflufenzopyr, 2,4-dichlorophenoxyacetic acid (2,4-D), 4-(2,4-dichlorophenoxy)butyric acid (2,4-DB), fluroxypyr, mecoprop, 2-methyl-4-chlorophenoxyacetic acid (MCPA), picloram, quinclorac, 2,4,5-trichlorophenoxyacetic acid (2,4,5-T), or triclopyr.
43. The composition of embodiment 35, wherein said at least one herbicide is an ALS/AHAS Herbicide.
44. The composition of embodiment 43, wherein said ALS/AHAS Herbicide is bensulfuron, chlorimuron, cloransulam, chlorsulfuron, diclosulam, florasulam, flucarbazone, flumetsulam, foramsulfuron, halosulfuron, imazamethabenz, imazamox, imazapic, imazapyr, imazaquin, imazethapyr, mesosulfuron, metsulfuron, nicosulfuron, penoxsulam, primisulfuron, propoxycarbazone, prosulfuron, pyrithiobac, pyroxsulam, rimsulfuron, sulfometuron, sulfosulfuron, thifensulfuron, triasulfuron, tribenuron, trifloxysulfuron, or triflusulfuron.
45. The composition of embodiment 35, wherein said at least one herbicide is an ACCase Inhibitor Herbicide.
46. The composition of embodiment 45, wherein said ACCase Inhibitor Herbicide is butroxydim, clethodim, cyhalofop, diclofop, fenoxaprop, fluazifop, haloxyfop, pinoxaden, quizalofop, sethoxydim, or tralkoxydim.
47. The composition of embodiment 35, wherein said at least one herbicide is a Carotenoid Biosynthesis Inhibitor Herbicide.
48. The composition of embodiment 47, wherein said Carotenoid Biosynthesis Inhibitor Herbicides is amitrole, clomazone, fluridone, isoxaflutole, mesotrione, norflurazon, pyrasulfotole, tembotrione, or topramezone.
49. The composition of embodiment 35, wherein said at least one herbicide is a Cellulose Inhibitor Herbicide.
50. The composition of embodiment 49, wherein said Cellulose Inhibitor Herbicide is dichlobenil, flupoxam, indaziflam, isoxaben, and quinclorac.
51. The composition of embodiment 35, wherein said at least one herbicide is glyphosate.
52. The composition of embodiment 35, wherein said at least one herbicide is glufosinate.
53. The composition of embodiment 35, wherein said at least one herbicide is a Lipid Synthesis Inhibitor Herbicide.
54. The composition of embodiment 53, wherein said Lipid Synthesis Inhibitor Herbicide is acetochlor, alachlor, bensulide, benthiocarb, chloroacetamide, cycloate, dimethenamid, S-ethyl-N,N-dipropylthiocarbamate (EPTC), ethofumesate, flufenacet, metolachlor, napropamide, propachlor, or triallate.
55. The composition of embodiment 35, wherein said at least one herbicide is a Microtubule Assembly Inhibitor Herbicide.
56. The composition of embodiment 55, wherein said Microtubule Assembly Inhibitor Herbicide is benefin, benfluralin, dimethyl tetrachloroterephthalate (DCPA), dithiopyr, ethalfluralin,
57. The composition of embodiment 35, wherein said at least one herbicide is a Photosystem Inhibitor Herbicide.
58. The composition of embodiment 57, wherein said Photosystem Inhibitor Herbicide is atrazine, diquat, diuron, linuron, metribuzin, paraquat, or simazine.
59. The composition of any one of embodiments 35-58 wherein said at least one ascaroside comprises an ascaroside having the structure (I):

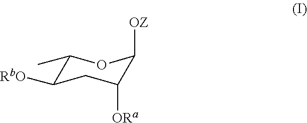

where:
Z is an optionally substituted C₃₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{∘}), a C₂₋₂₀ carbamate (e.g. -a moiety —C(O)N(Re) 2), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule. Where R^{∘} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.
60. The composition of embodiment 59, wherein Z is selected from the group consisting of:
   i. —CH(CH₃)—R¹, where R¹ is an optionally substituted C₁₋₄₀ aliphatic group
   ii. —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   iii. —CH(CH₃)—(CH₂), —CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   iv. —CH(CH₃)—(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   v. —CH(CH₃)—(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   vi. —(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   vii. —(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
   viii. —(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide; and
   ix. —(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
61. The composition of embodiment 47, wherein Z is:
   (x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally optionally substituted heteroaryl group, a polymer chain, an amino acid, a peptide, a nucleotide, or a linkage via a bond or a carbon-containing linker moiety to another ascaroside molecule;
   (xii) —CH(CH₃)—(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiii) —CH(CH₃)—(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
   (xvi) —(CH₂)ₙ—CH(OH)—CH₂—CON(R³)₂, where n is an integer from 1 to 40, and each R³ is independently —H, an optionally substituted C₁₋₂₀ aliphatic group, an optionally optionally substituted heteroaryl group, a polymer chain, an amino acid, a peptide, a nucleotide, or a linkage via a bond or a carbon-containing linker moiety to another ascaroside molecule;
   (xvii) —(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
   (xviii) an optionally unsaturated, optionally substituted C₂₋₄₀ sidechain terminating in a chain end comprising a nitrogen-, oxygen- or sulfur-containing functional group.
62. The composition of embodiment 60 or 61, wherein R^{a} and R^{b} are each —H.
63. The composition of any one of embodiments 59-62, wherein Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.
64. The composition of any one of embodiments 35-63, wherein said at least one ascaroside comprises an ascaroside selected from the group consisting of ascr #9, ascr #10, ascr #16, ascr #18, ascr #20, ascr #22, and ascr #24.
65. The composition of any one of embodiments 35-63, wherein said at least one ascaroside comprises ascr #18.
66. The composition of any one of embodiments 35-65, wherein said composition is part of a tank mix.
67. The composition of any one of embodiments 35-65, wherein said composition is in a solid form.
68. The composition of claim 67, wherein said solid form comprises powder or granules.
69. The composition of any one of embodiments 35-65, wherein said composition is in liquid form. 70. The composition of claim 69, wherein said liquid form is a sprayable formulation.
71. The composition of any one of embodiments 35-70, wherein the composition is stable for a period of greater than 6 months.
72. The composition of any one of embodiments 35-71, wherein said composition further comprises one or more additional components selected from the group consisting of surfactants, including emulsifiers, dispersants, foam-formers, colorants, processing aids, lubricants, fillers, reinforcements, flame retardants, light stabilizers, ultraviolet radiation absorbers, weather stabilizers, plasticizers, release agents, perfumes, heat-retaining additives (e.g., silica), cross-linking agents, antioxidants, anti-foaming agents, buffers, pH modifiers, compatibility agents, drift control additives, extenders/stickers, tackifiers, plant penetrants, safeners, spreaders, and wetting agents.

### EXAMPLES

### Example 1: Ascaroside Tank Mix Trial with Glyphosate in Soybeans

A trial was performed to evaluate the post-emergence application of Phytalix in combination with Roundup PowerMax3® (a commercial glyphosate fomulation). The trial was organized in a randomized complete block design with four replications per treatment and a plot size of 10 ft by 30 ft. The trial was replicated at three separate sites, A tank mix was created with Roundup PowerMax3 at 20 oz/acre (0.91 lb AI/acre), ammonium sulfate (3.4 lb/acre) and 50 mg/acre Phytalix® (a formulation containing ascarosides) The mixture was applied to the plots when the soybean plants were at the V3-V4 growth stage and the targeted grass and broadleaf weeds were about 3-6 inches tall.

### Example 2: Ascaroside Tank Mix Trial with Glufosinate in Soybeans

A trial was performed to evaluate the post-emergence application of Phytalix in combination with Liberty® (a commercial glufosinate formulation). The trial was deployed in a randomized complete block design with four replications per treatment and a plot size of 10 ft by 30 ft. The trial was replicated at three separate sites. A tank mix formulation was created by combining Liberty 32 fl oz/acre (0.58 lb ai/acre) with ammonium sulfate (3 lb/acre) and 50 mg/acre of the ascaroside ascr #18. The mixture was applied to the plots when the soybean plants were at the V3-V4 growth stage and the targeted grass and broadleaf weeds were about 3-6 inches tall.

The plots in both Examples 1 and 2 are evaluated as follows: Weed control in each plot is rated as % control 7 and 14 days after application. A Phytotoxicity rating of each plot is also measured at 7 and 14 days after application. Subsequent the 14 days after ratings, a blanket herbicide application is made to maintain the trial weed free throughout the season to evaluate harvest. Disease ratings are collected when the soybean crop reaches approximately the R6-R7 growth stage. The disease evaluation includes % disease incidence and severity. The plots were harvested separately and the yield measured and reported as bushel/acre. Weeds at the sites tested included Redroot pigweed (Amaranthus retroflexus), Goosegrass (Eleusine indica), Velvetleaf (Abutilon theophrasti), Broadleaf Signal Grass (Brachiaria platyphyla), Purslane (Portulaca olera), Bittercress (Cardamine sp.), Palmer Amaranth (Amaranthus palmerii), Common Barnyard Grass (Echinochloa crus-galli), Giant Foxtail (Setaria faberi), and Tall Waterhemp (Amaranthus tuberculatus). The level of weed control and yield at all sites was unaffected by inclusion of ascarosides with the herbicide application in this study. No significant plant disease or phytotoxicity was observed in any treatment group in this study.

It is contemplated that compounds, compositions, and methods of the present application encompass variations and adaptations developed using information from the embodiments described in the present disclosure. Adaptation or modification of the methods and processes described in this specification may be performed by those of ordinary skill in the relevant art.

It will be appreciated that use of headers in the present disclosure are provided for the convenience of the reader. The presence and/or placement of a header is not intended to limit the scope of the subject matter described herein. Unless otherwise specified, embodiments located in one section of the application apply throughout the application to other embodiments, both singly and in combination.

Throughout the description, where compositions, compounds, or products are described as having, including, or comprising specific components, or where processes and methods are described as having, including, or comprising specific steps, it is contemplated that, additionally, there are articles, devices, and systems of the present application that consist essentially of, or consist of, the recited components, and that there are processes and methods according to the present application that consist essentially of, or consist of, the recited processing steps.

It should be understood that the order of steps or order for performing certain action is immaterial so long as the described method remains operable. Moreover, two or more steps or actions may be conducted simultaneously.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

What is claimed is:

1. A method for reducing phytotoxic side effects on plants associated with application of an herbicide, said method comprising contacting a plant or a plant part with an effective amount of a combination of agents, said agents comprising at least one ascaroside and at least one herbicide.

2. The method of claim 1, wherein said effective amount reduces phytotoxic side effects on crop plants as compared to phytotoxic side effects on plants associated with application of the herbicide alone.

3. The method of claim 1 or 2, wherein said effective amount reduces the phytotoxicity rating on crop plants as compared to the phytotoxicity rating on plants associated with application of the herbicide alone.

4. The method of any one of claims 1-3, wherein the herbicide is a PPO Herbicide, an Auxin Herbicide, an ALS/AHAS Herbicide, an ACCase Inhibitor Herbicide, a Carotenoid Biosynthesis Inhibitor Herbicide, a Cellulose Inhibitor Herbicide, an EPSP Inhibitor Herbicide, a Glutamine Synthesis Inhibitor Herbicide, a Lipid Synthesis Inhibitor Herbicide, a Microtubule Assembly Inhibitor Herbicide or a Photosystem Inhibitor Herbicide.

5. The method of any one of claims 1-4, wherein the herbicide is selected from the groups of: carbamates; thiocarbamates; haloacetanilides; substituted phenoxy-, naphthoxy- and phenoxyphenoxy carboxylic acid derivatives; heteroaryloxyphenoxyalkane carboxylic acid derivatives; quinolyloxy-, quinoxalyloxy-, pyridyloxy-, benzoxazolyloxy- and benzothiazolyloxyphenoxyalkane carboxylic acid esters; cyclohexanedione derivatives; imidazolinones; pyrimidinyloxypyridincarboxylic acid derivatives; pyrimidyloxybenzoic acid derivatives; sulfonylureas; triazolopyrimidinesulfonamide derivatives; S—(N-aryl-N-alkylcarbamoylmethyl)dithiophosphoric esters; hormone-type herbicides; pyridinecarboxylic acids; triazinones; triazolinones; pyridinecarboxamides; hydroxybenzonitriles; isoxazoles; phenoxyphenoxy- and heteroaryloxyphenoxy carboxylic acid esters and salts, sulfonylureas, imidazolinones; and isoxazoles.

6. The method of any one of claims 1-5, wherein said at least one herbicide is glyphosate.

7. The method of any one of claims 1-5, wherein said at least one herbicide is glufosinate.

8. The method of any one of claims 1-7, wherein said at least one ascaroside comprises an ascaroside having the structure (I): 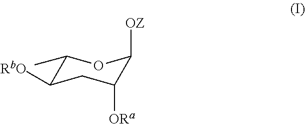
where:
Z is an optionally substituted C₃₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{c}), a C₂₋₂₀ carbamate (e.g. -a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule. Where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

9. The method of claim 8, wherein Z is selected from the group consisting of:
i. —CH(CH₃)—R¹, where R¹ is an optionally substituted C₁₋₄₀ aliphatic group
ii. —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
iii. —CH(CH₃)—(CH₂)ₙ—CH—CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
iv. —CH(CH₃)—(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
v. —CH(CH₃)—(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
vi. —(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
vii. —(CH₂)ₙ—CH—CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
viii. —(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide; and
ix. —(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

10. The method of claim 8, wherein Z is selected from the group consisting of:
(x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally optionally substituted heteroaryl group, a polymer chain, an amino acid, a peptide, a nucleotide, or a linkage via a bond or a carbon-containing linker moiety to another ascaroside molecule;
(xii) —CH(CH₃)—(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiii) —CH(CH₃)—(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xvi) —(CH₂)ₙ—CH(OH)—CH₂—CON(R³)₂, where n is an integer from 1 to 40, and each R³ is independently —H, an optionally substituted C₁₋₂₀ aliphatic group, an optionally optionally substituted heteroaryl group, a polymer chain, an amino acid, a peptide, a nucleotide, or a linkage via a bond or a carbon-containing linker moiety to another ascaroside molecule;
(xvii) —(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
(xviii) an optionally unsaturated, optionally substituted C₂₋₄₀ sidechain terminating in a chain end comprising a nitrogen-, oxygen- or sulfur-containing functional group.

11. The method of any one of claims 1-10, wherein said at least one ascaroside comprises an ascaroside selected from the group consisting of ascr #9, ascr #10, ascr #16, ascr #18, ascr #20, ascr #22, and ascr #24.

12. The method of any one of claims 1-11, wherein said at least one ascaroside comprises ascr #18.

13. The method of any one of claims 1-12, wherein said at least one ascaroside and said at least one herbicide are applied simultaneously.

14. The method of claim 13, wherein said at least one ascaroside and said at least one herbicide are combined together in a tank mix.

15. The method of any one of claims 1-12, wherein said at least one ascaroside and said at least one herbicide are applied sequentially.

16. The method of any one of claims 1-15, wherein said combination is used as a seed coating.

17. A composition comprising at least one ascaroside and at least one herbicide.

18. The composition of claim 17, wherein said at least one ascaroside and said at least one herbicide are present in effective amounts.

19. The composition of claim 18, wherein said effective amount reduces phytotoxic side effects on crop plants as compared to phytotoxic side effects on plants associated with application of the herbicide alone.

20. The composition of claim 17 or 18, wherein said effective amount reduces the phytotoxicity rating on crop plants as compared to the phytotoxicity rating on plants associated with application of the herbicide alone.

21. The composition of any one of claims 17-20, wherein the herbicide is a PPO Herbicide, an Auxin Herbicide, an ALS/AHAS Herbicide, an ACCase Inhibitor Herbicide, a Carotenoid Biosynthesis Inhibitor Herbicide, a Cellulose Inhibitor Herbicide, an EPSP Inhibitor Herbicide, a Glutamine Synthesis Inhibitor Herbicide, a Lipid Synthesis Inhibitor Herbicide, a Microtubule Assembly Inhibitor Herbicide or a Photosystem Inhibitor Herbicide.

22. The composition of any one of claims 17-20, wherein the herbicide is selected from the groups of: carbamates; thiocarbamates; haloacetanilides; substituted phenoxy-, naphthoxy- and phenoxyphenoxy carboxylic acid derivatives; heteroaryloxyphenoxyalkane carboxylic acid derivatives; quinolyloxy-, quinoxalyloxy-, pyridyloxy-, benzoxazolyloxy- and benzothiazolyloxyphenoxyalkane carboxylic acid esters; cyclohexanedione derivatives; imidazolinones; pyrimidinyloxypyridincarboxylic acid derivatives; pyrimidyloxybenzoic acid derivatives; sulfonylureas; triazolopyrimidinesulfonamide derivatives; S—(N-aryl-N-alkylcarbamoylmethyl)dithiophosphoric esters; hormone-type herbicides; pyridinecarboxylic acids; triazinones; triazolinones; pyridinecarboxamides; hydroxybenzonitriles; isoxazoles; phenoxyphenoxy- and heteroaryloxyphenoxy carboxylic acid esters and salts, sulfonylureas, imidazolinones; and isoxazoles.

23. The composition of any one of claims 17-20, wherein said at least one herbicide is glyphosate.

24. The composition of any one of claims 17-20, wherein said at least one herbicide is glufosinate.

25. The composition of any one of claims 17-24 wherein said at least one ascaroside comprises an ascaroside having the structure (I): 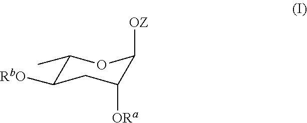
where:
Z is an optionally substituted C₃₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{c}), a C₂₋₂₀ carbamate (e.g. -a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule. Where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

26. The composition of claim 25, wherein Z is selected from the group consisting of:
i. —CH(CH₃)—R¹, where R¹ is an optionally substituted C₁₋₄₀ aliphatic group
ii. —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
iii. —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
iv. —CH(CH₃)—(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
v. —CH(CH₃)—(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
vi. —(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
vii. —(CH₂)ₙ—CH—CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide;
viii. —(CH₂)ₙ—CH(OH)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide; and
ix. —(CH₂)ₙ—C(O)—CH₂—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

27. The composition of claim 25, wherein Z is:
(x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xii) —CH(CH₃)—(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiii) —CH(CH₃)—(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xvi) —(CH₂)ₙ—CH(OH)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xvii) —(CH₂)ₙ—C(O)—CH₂—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
(xviii) an optionally unsaturated, optionally substituted C₂₋₄₀ sidechain terminating in a chain end comprising a nitrogen-, oxygen- or sulfur-containing functional group.

28. The composition of any one of claims 17-27, wherein said at least one ascaroside comprises an ascaroside selected from the group consisting of ascr #9, ascr #10, ascr #16, ascr #18, ascr #20, ascr #22, and ascr #24.

29. The composition of any one of claims 17-27, wherein said at least one ascaroside comprises ascr #18.

30. The composition of any one of claims 17-29, wherein said composition is part of a tank mix.

31. The composition of any one of claims 17-29, wherein said composition is in a solid form.

32. The composition of claim 31, wherein said solid form comprises powder or granules.

33. The composition of any one of claims 17-29, wherein said composition is in liquid form.

34. The composition of claim 33, wherein said liquid form is a sprayable formulation.

35. The composition of any one of claims 17-34, wherein the composition is stable for a period of greater than 6 months.

36. The composition of any one of claims 17-35, wherein said composition further comprises one or more additional components selected from the group consisting of surfactants, including emulsifiers, dispersants, foam-formers, colorants, processing aids, lubricants, fillers, reinforcements, flame retardants, light stabilizers, ultraviolet radiation absorbers, weather stabilizers, plasticizers, release agents, perfumes, heat-retaining additives (e.g., silica), cross-linking agents, antioxidants, anti-foaming agents, buffers, pH modifiers, compatibility agents, drift control additives, extenders/stickers, tackifiers, plant penetrants, safeners, spreaders, and wetting agents.
